(19) United States
(12) Patent Application Publication
(10) Pub. No.: US 2012/0050838 A1
(43) Pub. Date: Mar. 1, 2012

(54) ELECTROCHROMIC DISPLAY APPARATUS

(76) Inventors: Shigenobu Hirano, Kanagawa (JP); Tohru Yashiro, Kanagawa (JP); Takeshi Shibuya, Ibaraki (JP); Hiroshi Kondo, Kanagawa (JP); Yuki Nakamura, Tokyo (JP); Yukiko Abe, Kanagawa (JP)

(21) Appl. No.: 13/258,503

(22) PCT Filed: May 1, 2009
(86) PCT No.: PCT/JP2010/057645

§ 371 Date: Sep. 22, 2011

(30) Foreign Application Priority Data
Nov. 4, 2010 (JP) 2009-112006

(51) Int. Cl. G02F 1/155

(52) U.S. Cl. 359/273; 359/267

(57) ABSTRACT

An electrochromic display apparatus includes a display substrate; an opposite substrate disposed opposite the display substrate; an opposite electrode disposed on the opposite substrate; a plurality of display electrodes disposed between the display substrate and the opposite electrode, the display electrodes being electrically isolated from each other; a plurality of electrochromic layers disposed on the corresponding display electrodes; and an electrolyte disposed between the display electrodes and the opposite electrode. An electric resistance between one display electrode and another display electrode is greater than an electric resistance of the one or the other display electrode. One or more display electrodes that are disposed between the display electrode closest to the display substrate and the opposite electrode are configured to be permeable to the electrolyte.

### TECHNICAL FIELD

The present invention generally relates to electrochromic display apparatuses and methods for manufacturing and driving electrochromic display apparatuses. In particular, the invention relates to an electrochromic display apparatus capable of independently displaying multiple colors and methods for manufacturing and driving such an electrochromic display apparatus.

### BACKGROUND ART

Various electronic paper technologies have been developed to realize electronic paper that can replace paper as a display medium. Electronic paper generally refers to a display unit that mimics the characteristics of a sheet of paper. For this reason, different characteristics are required of electronic paper than those required of conventional display units, such as cathode-ray tubes (CRT) and liquid crystal displays. Some of the requirements of electronic paper include use of a light-reflecting (rather than light-emitting) display principle; high white reflectivity; high contrast ratio; high display resolution; memory (image-holding) effect; low-voltage drive capability; small size and light-weight; and low cost. Among the characteristics mentioned above, particularly high levels are required of those characteristics related to display quality, such as white reflectivity, which is desired to be comparable to that of paper, and contrast ratio.

Various operating principles of electronic paper have been developed. Examples include a reflecting liquid crystal type, an electrophoresis type, and a toner migration type. However, it is very difficult with any of those known technologies to provide a multicolor display while maintaining a high white reflectivity and a high contrast ratio. While multicolor display may be realized by use of a color filter, the color filter per se absorbs light, resulting in a decrease in reflectivity. Further, because a color filter separates an individual pixel into red (R), green (G), and blue (B), the reflectivity of the display apparatus decreases and, as a result, its contrast ratio also decreases. Decrease in white reflectivity and/or contrast ratio adversely affects visibility, thereby making it difficult to use the display apparatus as practical electronic paper.

Another electronic paper technology employs the principle of electrochromism to realize a reflecting display apparatus without using the aforementioned color filter. Electrochromism refers to a phenomenon in which the color of a compound can be reversibly changed based on a reversible redox reaction caused by voltage application. An electrochromic display apparatus utilizes the appearance and disappearance of color on a compound (“electrochromic compound”) that exhibits the electrochromism phenomena. The electrochromic display apparatus is reflective, has memory effect, and can be operated at low voltage. For these reasons, research and development of electrochromic technology are being actively carried out from various aspects, including material development and device design, to provide a feasible technology for realizing useful electronic paper.

However, the electrochromic display technology is disadvantageous in that because of its principle of appearance and disappearance of color based on redox reaction, the rate of appearance or disappearance of color (“color appearance/disappearance response rate”) is low. Japanese Laid-Open Patent Application No. 2001-510590 (Patent Document 1) discusses improvement in color appearance/disappearance response rate by immobilizing an electrochromic compound near an electrode. Patent Document 1 suggests that the time required for color appearance/disappearance improved from the order of several tens seconds to approximately one second in the case of appearance of blue from no color or disappearance of blue to no color. However, such an improvement is insufficient, and the development of a useful electrochromic display apparatus requires a further improvement in color appearance/disappearance response rate.

Still, the electrochromic display technology, with its capability of exhibiting various colors depending on the structure of the electrochromic compound used, is expected to provide a useful multicolor display apparatus. Several multicolor display apparatuses that utilize the electrochromic display technology are known. For example, Japanese Laid-Open Patent Application No. 2003-121883 (Patent Document 2) discloses a multicolor display apparatus that employs electrochromic layers of fine particles of multiple kinds of electrochromic compounds. Specifically, Patent Document 2 discusses a multicolor display apparatus that employs multiple layers of electrochromic compounds that include polymer compounds having plural functional groups with different color-exhibiting voltages.

Japanese Laid-Open Patent Application No. 2006-106669 (Patent Document 3) discloses a display apparatus capable of exhibiting multiple colors by forming plural electrochromic layers on an electrode, the layers exhibiting colors at different voltage or current values. Specifically, Patent Document 3 discusses a multicolor display apparatus having a display layer formed by layering or mixing plural electrochromic compounds that have different threshold voltages or charge amounts required for color appearance.

Japanese Laid-Open Patent Application No. 2003-270671 (Patent Document 4) discloses a multicolor display apparatus having plural layers of structure units including pairs of transparent electrodes between which an electrochromic layer and an electrolyte are disposed. Japanese Laid-Open Patent Application No. 2004-151265 (Patent Document 5) discloses a multicolor display apparatus compatible with the three RGB colors, wherein a passive matrix panel and an active matrix panel are formed by using the structure units according to Patent Document 4.

Such known multicolor display apparatuses utilizing the electrochromic display technology have the following disadvantages. In the technology according to Patent Document 2, because the layered electrochromic compounds exhibit different colors at different voltages, multiple colors cannot be exhibited simultaneously, although any one color may be exhibited by controlling the applied voltage.

In the technology according to Patent Document 3, while plural colors may be exhibited simultaneously because of the presence of plural kinds of electrochromic compounds capable of exhibiting different colors, complex voltage and current control is required for exhibiting a desired color selectively.

The technologies according to Patent Documents 4 and 5 require a pair of layers of transparent electrodes for causing one electrochromic layer to exhibit a color. Thus, a large number of electrode layers are required when multiple electrochromic layers are stacked, resulting in a decrease in reflectivity or contrast.

### SUMMARY OF THE INVENTION

The disadvantages of the prior art may be overcome by the present invention which, in one aspect, is an electrochromic display apparatus including a display substrate; an opposite substrate disposed opposite the display substrate; an opposite electrode disposed on the opposite substrate; a plurality of display electrodes disposed between the display substrate and the opposite electrode, the display electrodes being separated from each other; a plurality of electrochromic layers disposed on the corresponding display electrodes; and an electrolyte disposed between the display electrodes and the opposite electrode. An electric resistance between one display electrode and another display electrode is greater than an electric resistance of the one or the other display electrode. One or more display electrodes disposed between the display electrode disposed the closest to the display substrate and the opposite electrode are configured to be permeable to the electrolyte.

### BRIEF DESCRIPTION OF THE DRAWINGS

The above and further advantages of the invention may be better understood by referring to the following description in conjunction with the accompanying figures in which:

FIG. 1 is a cross section of an electrochromic display apparatus according to a first embodiment of the present invention;

FIG. 2 is a perspective view of a display substrate of the electrochromic display apparatus according to the first embodiment;

FIG. 3 is a cross section of the electrochromic display apparatus according to a first variation of the first embodiment;

FIG. 4 is a perspective view of the electrochromic display apparatus according to a second variation of the first embodiment;

FIG. 5 is a cross section of the electrochromic display apparatus according to a third variation of the first embodiment;

FIG. 6A is a cross section of the electrochromic display apparatus according to a fourth variation of the first embodiment;

FIG. 6B is a perspective view of an opposite substrate of the electrochromic display apparatus of the fourth variation;

FIG. 7 is a flowchart of a method of manufacturing the electrochromic display apparatus according to the first embodiment;

FIG. 8 is a cross section of an image display apparatus according to a second embodiment of the present invention;

FIG. 9 is a perspective view of a display substrate of the image display apparatus;

FIG. 10 illustrates a drive circuit for the image display apparatus;

FIG. 11A is a plan view of an electrochromic display apparatus according to Example 1;

FIG. 11B is a cross section taken along line A-A of FIG. 11A;

FIG. 11C is a cross section taken along line B-B of FIG. 11A;

FIG. 12 is a graph illustrating the result of measurement of an inter-electrode resistance between the first and the second display electrodes of the electrochromic display apparatus according to Examples 1 and 2;

FIG. 13 is a graph illustrating the relationship between the number of times of application of pulse voltage to the first display electrode of the electrochromic display apparatus of Example 4 and white reflectivity;

FIG. 14 is a graph illustrating the relationship between the number of times of application of pulse voltage to the second display electrode of the electrochromic display apparatus according to Example 4 and white reflectivity;

FIG. 15 is a graph illustrating the reflectance spectrum during the appearance of blue from the electrochromic display apparatus according to Example 4;

FIG. 16 is a graph illustrating the reflectance spectrum during the appearance of green from the electrochromic display apparatus according to Example 4;

FIG. 17 is a graph illustrating the reflectance spectrum during the appearance of black from the electrochromic display apparatus according to Example 4;

FIG. 18A is a plan view of an electrochromic display apparatus according to Example 5;

FIG. 18B is a cross section taken along line A-A of FIG. 18A;

FIG. 18C is a cross section taken along line B-B of FIG. 18A;

FIGS. 19A through 19C illustrate various ways in which voltage is applied to the electrochromic display apparatus according to Example 5 for causing the electrochromic display apparatus to display various colors;

FIG. 20 is a graph illustrating the reflectance spectrum during appearance of magenta from the electrochromic display apparatus according to Example 6; and

FIG. 21 is a graph illustrating the reflectance spectrum during the appearance of yellow from the electrochromic display apparatus according to Example 6.

### BEST MODE FOR CARRYING OUT THE INVENTION

Various embodiments of the present invention are described below with reference to the drawings, wherein like reference numerals designate identical or corresponding parts throughout the several views.

### Embodiment 1

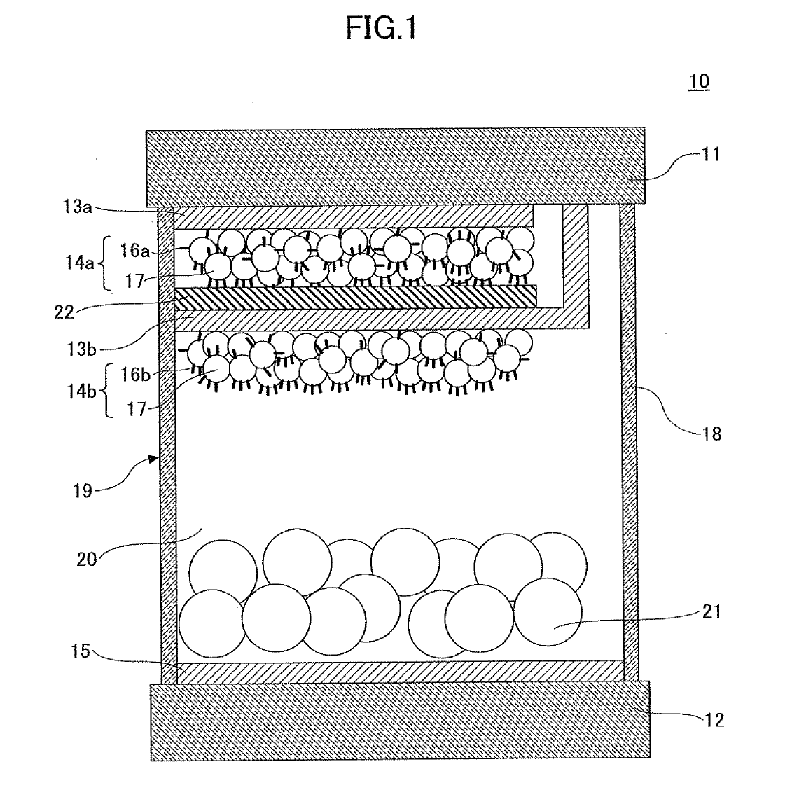

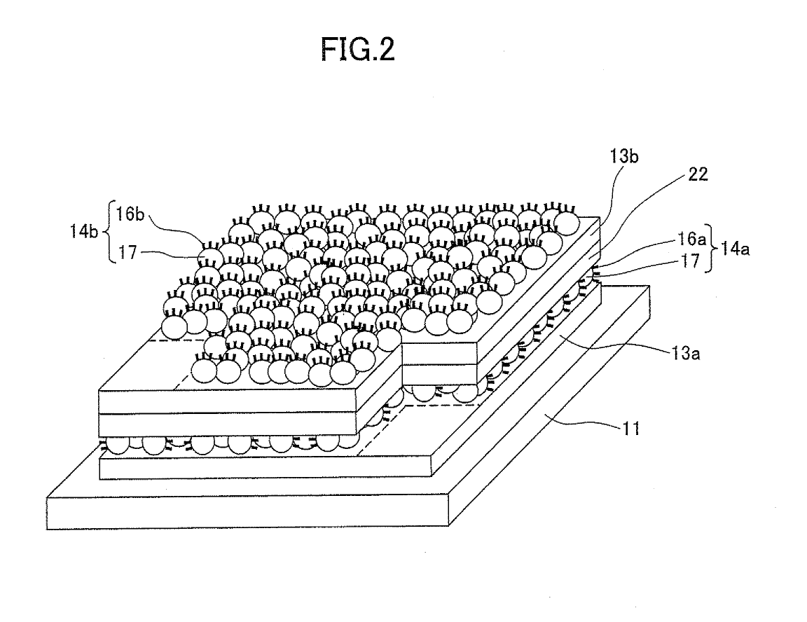

FIG. 1 is a cross section of an electrochromic display apparatus 10 according to an embodiment of the present invention. The electrochromic display apparatus 10 includes a display substrate 11, an opposite substrate 12 disposed opposite the display substrate 11, an opposite electrode 15 disposed on the opposite substrate 12, and a cell 19. The cell 19 is formed by connecting the display substrate 11 and the opposite substrate 12 via a spacer 18. FIG. 2 is a perspective view of the electrochromic display apparatus 10. First, the structure of the electrochromic display apparatus 10 according to the present embodiment is described.

As illustrated in FIGS. 1 and 2, the electrochromic display apparatus 10 includes a first display electrode 13a formed on the display substrate 11; a first electrochromic layer 14a disposed on the first display electrode 13a; an insulating layer 22 disposed on the first electrochromic layer 14a; a second display electrode 13b disposed on the insulating layer 22; and a second electrochromic layer 14b disposed on the second display electrode 13b. Thus, the display substrate 11 supports a stack of the various layers.

The first display electrode 13a is configured to control a potential between the first electrochromic layer 14a and the opposite electrode 15 in order to cause the first electrochromic layer 14a to exhibit a color. The first electrochromic layer 14a includes a first electrochromic compound 16a and a metal oxide 17 that supports the first electrochromic compound 16a. The first electrochromic compound 16a exhibits a color based on a redox reaction. The metal oxide 17 is configured to speed up the color appearance/disappearance rate as well as supporting the first electrochromic compound 16a.

While FIG. 1 illustrates single molecules of the electrochromic compound 16a being adsorbed on the metal oxide 17, this is merely an illustration of an ideal state. In fact, the configuration of the first electrochromic compound 16a is not particularly limited as long as the electrochromic compound 16a is immobilized and has an electrical connection such that the exchange of electrons due to the oxidation and reduction of the electrochromic compound 16a is not interfered with. Preferably, the electrochromic compound 16a and the metal oxide 17 may be mixed in a single layer.

The insulating layer 22 is provided to electrically isolate the first display electrode 13a from the second display electrode 13b. Preferably, the insulating layer 22 may not be provided if a sufficient resistance can be ensured between the first and the second display electrodes 13a and 13b. The resistance between the first and the second display electrodes 13a and 13b may be increased by increasing the film thickness of the first electrochromic layer 14a.

The second display electrode 13b is similar to the first display electrode 13a in that it is configured to control a potential between the second electrochromic layer 14b and the opposite electrode 15 in order to cause the second electrochromic layer 14b to exhibit a color. The second electrochromic layer 14b includes a second electrochromic compound 16b and the metal oxide 17 supporting the second electrochromic compound 16b. The second electrochromic compound 16b is configured to exhibit a color in response to a redox reaction. The metal oxide 17 is provided to increase the color appearance/disappearance rate as well as supporting the second electrochromic compound 16b. The second electrochromic compound 16b and the first electrochromic compound 16a are configured to exhibit different colors.

The resistance between the first and the second display electrodes 13a and 13b (“inter-electrode resistance”) needs to be high enough that their potentials with the opposite electrode 15 can be independently controlled. Specifically, the inter-electrode resistance needs to be at least greater than the sheet resistance of either the first display electrode 13a or the second display electrode 13b. If the inter-electrode resistance is less than the sheet resistance of the first display electrode 13a or the second display electrode 13b, when a voltage is applied to the first or the second display electrode 13a or 13b, approximately the same voltage may be applied to the other display electrode. As a result, it becomes impossible to cause the corresponding electrochromic layers 14a and 14b of the first and the second display electrodes 13a and 13b to independently exhibit or not exhibit color. Preferably, the inter-electrode resistance is 500 times or more than that of the sheet resistance of the respective display electrodes.

In order to obtain proper insulation, the inter-electrode resistance may be controlled by changing the thickness of the first electrochromic layer 14a. Alternatively, the inter-electrode resistance may be controlled by changing the thickness of the insulating layer 22 disposed on the first electrochromic layer 14a.

The inter-electrode resistance of the first and the second display electrodes 13a and 13b may correspond to an electric resistance between one of a plurality of display electrodes and another of the plurality of display electrodes.

The opposite electrode 15 disposed on the opposite substrate 12 is configured to control the potential between the first and the second display electrodes 13a and 13b and the opposite electrode 15 in order to cause the first and the second electrochromic layers 14a and 14b to exhibit colors. The cell 19 is filled with an electrolyte 20. The electrolyte 20 is provided to cause ions (charges) to move between the first or the second display electrode 13a or 13b and the opposite electrode 15 in order to cause the first or the second electrochromic layer 14a or 14b to exhibit a color. The electrolyte 20 may be supported by a polymer. In this case, color appearance/disappearance areas (i.e., pixels) may be easily formed by patterning of the polymer.

The cell 19 may also contain a white reflecting layer 21. The white reflecting layer 21 may be provided to improve white reflectivity of the electrochromic display apparatus 10. The white reflecting layer 21 may be formed by injecting the cell 19 with the electrolyte 20 in which white pigment particles are dispersed. Alternatively, the white reflecting layer 21 may be formed by coating the opposite electrode 15 with a resin in which white pigment particles are dispersed.

The white reflecting layer 21 may be disposed between one of the various layers (including the first and the second display electrodes 13a and 13b, the first and the second electrochromic layers 14a and 14b, and the insulating layer 22) that is disposed closest to the opposite substrate 12, such as the electrochromic layer 14b in FIG. 1, and the opposite electrode 15. Preferably, the white reflecting layer 21 may be disposed on the side of the opposite substrate 12 opposite to the side on which the opposite electrode 15 is formed.

Further preferably, a protection layer of organic polymer material may be formed on a surface of the first or the second electrochromic layer 14a or 14b on the side facing the display substrate 11. In this way, improved adhesion/sealing may be obtained between the first or the second electrochromic layer 14a or 14b and their respective adjacent layers, and also the resistance of the first or the second electrochromic layer 14a or 14b to a solvent can be improved, thereby improving the durability of the electrochromic display apparatus 10.

Preferably, an inorganic protection layer may be formed between the second electrochromic layer 14b and the electrolyte 20. In this way, improved anti-dissolving and corrosion resistance of the second electrochromic layer 14b against the electrolyte 20 may be obtained, thereby enhancing the durability of the electrochromic display apparatus 10.

Hereafter, a multicolor display operation of the electrochromic display apparatus 10 is described. The above-described structure of the electrochromic display apparatus 10 easily enables multicolor display. Namely, because the first and the second display electrodes 13a and 13b are isolated by the insulating layer 22, the potentials of the first and second display electrodes 13a and 13b with the opposite electrode 15 can be independently controlled. This makes it possible to cause the first electrochromic layer 14a disposed on the first display electrode 13a and the second electrochromic layer 14b disposed on the second display electrode 13b to independently exhibit or not exhibit color.

Because the first and second electrochromic layers 14a and 14b are layered on the display substrate 11, multicolor display can be provided depending on the color appearance/disappearance pattern of the first and second electrochromic layers 14a and 14b. Namely, three different color appearance/disappearance patterns may be created: 1) Color appears from the first electrochromic layer 14a alone; 2) Color appears from the second electrochromic layer 14b alone; and 3) Color appears from both the first and second electrochromic layers 14a and 14b. For example, the first and second electrochromic layers 14a and 14b may be configured to exhibit two different colors selected from red, green, and blue to achieve multicolor display.

In the present embodiment, the white reflecting layer 21 disposed in the cell 19 provides enhanced white reflectivity. As a result, the decrease in reflectivity due to the layered structure of the first and second electrochromic layers 14a and 14b can be compensated for, thus enabling multicolor display with improved visibility.

Further, in accordance with the present embodiment, the first and second electrochromic compounds 16a and 16b are supported by the respective metal oxides 17. This structure enables multicolor display with an increased color appearance/disappearance response rate. This structure is particularly effective when an organic compound material with a low electron (or hole) mobility is used in the first or the second electrochromic compound 16a or 16b. This is because, in accordance with the present embodiment, the electrons (or holes) can move from the first or second display electrode 13a or 13b not via the first or second electrochromic compound 16a or 16b but via the metal oxide 17 that has a greater electron (or hole) mobility than the first or second electrochromic compound 16a or 16b. Thus, color appearance/disappearance can be caused at a high speed, which enables multicolor display with an increased color appearance/disappearance response rate.

In accordance with the present embodiment, the respective electrochromic layers 14a and 14b are injected with charges as the electrolyte 20 permeates throughout the electrochromic display elements of the electrochromic display apparatus 10 for color appearance/disappearance reaction. This means that application voltage and response rate may be affected by the degree of permeation of the electrolyte 20, so that color generation reaction may fail to occur depending on the degree of electrolyte permeation. Thus, the electrolyte should be caused to properly permeate among all of the first and second display electrodes 13a and 13b, the insulating layer 22, the first and second electrochromic layers 14a and 14b, and the white reflecting layer 21.

This may be achieved by various methods. For example, one method may involve layering the display electrodes 13a and 13b, the insulating layer 22, and the electrochromic layers 14a and 14b while they are permeated with an electrolyte solution during the manufacture of the elements. Another method may involve applying an electrolyte-containing polymer between the layers. In another method, a polymer membrane and the like containing an electrolyte may be used as the insulating layer 22. In yet another method, an electrolyte-containing resin may be used as a binder for the white particles in the white reflecting layer. Thus, the white reflecting layer may comprise a dispersion of white particles in an electrolyte-containing resin.

Alternatively, one display electrode disposed between another display electrode closest to the display substrate 11 and the opposite electrode 15, i.e., the second display electrode 13b in the present embodiment, may be configured to be permeable to the electrolyte 20. The insulating layer 22 may also be configured to be permeable to the electrolyte 20. An electrolyte layer may be disposed between any two layers of the first and second display electrodes 13a and 13b, the first and second electrochromic layers 14a and 14b, and the insulating layer 22.

Thus, in accordance with the present embodiment, plural display electrodes and electrochromic layers are layered, wherein the individual display electrodes and electrochromic layers are insulated from each other. Thus, the corresponding electrochromic layer alone of each display electrode, namely the electrochromic layer that is located between the opposite electrode and the particular display electrode, can be caused to exhibit or not exhibit color. This is how the first and second electrochromic layers can be individually controlled to exhibit or not exhibit color. However, if a high voltage is applied to one display electrode (such as the second display electrode 13b), charges may diffuse not just toward the corresponding electrochromic layer (such as the second electrochromic layer 14b) facing the opposite electrode 15 but also toward the opposite side of the display electrode (such as toward the first electrochromic layer 14a). As a result, color appearance/disappearance may be induced in the first electrochromic layer (such as the first electrochromic layer 14a) on the opposite side facing the display substrate 11 of the display electrode.

In order to prevent the above phenomena, one of the electrochromic layers that is closest to the display substrate 11, such as the first electrochromic layer 14a, may be provided with the highest threshold voltage for color appearance or disappearance. In this way, because there is no electrochromic layer on the opposite side of the display electrode (such as the first display electrode 13a) not facing the opposite electrode 15, application of a high voltage to the second display electrode 13b does not induce the aforementioned undesirable color appearance/disappearance reaction.

Next, materials used in the electrochromic display apparatus 10 according to the first embodiment are described. First, the materials of the display substrate 11 and the various layers formed on the display substrate 11 are described. The material of the display substrate 11 is not particularly limited as long as it is transparent. Examples include glass and plastic films.

The material of the first and second display electrodes 13a and 13b is not particularly limited as long as it is electrically conductive and optically transparent. These properties are required for enhancing the visibility of the colors exhibited by the electrochromic layers 14a and 14b. Examples of such a transparent conductive material include inorganic materials such as indium oxide doped with tin (“ITO”); tin oxide doped with fluorine (“FTO”); and tin oxide doped with antimony (“ATO”). A preferable example is an electrochromic film of an inorganic material that contains at least one of an indium oxide (“In oxide”), a tin oxide (“Sn oxide”) and zinc oxide (“Zn oxide”), the film being formed by a vacuum film forming method. Such In oxide, Sn oxide, and Zn oxide materials can be easily formed into a film by sputtering, and they also provide appropriate transparency and electrical conductivity. Among others, InSnO, GaZnO, SnO, In₂O₃, ZnO are particularly preferable.

The materials of the first and second electrochromic compounds 16a and 16b in the first and second electrochromic layers 14a and 14b may include materials that exhibit a change in color based on an oxidoreduction reaction. Examples of such materials include known electrochromic compounds of polymer type, pigment type, metal complex type, and metal oxide type.

Examples of the polymer-type and pigment-type electrochromic compounds include low-molecular-weight organic electrochromic compounds such as azobenzene, anthraquinone, diarylethene, dihydropyrene, styryl, styryl spiropyran, spirooxazine, spirothiopyran, thioindigo, tetrathiafulvalene, terephthalic acid, triphenylmethane, triphenylamine, naphthopyran, viologen, pyrazoline, phenazine, phenylenediamine, phenoxazine, phenothiazine, phthalocyanine, fluoran, fulgide, benzopyran, and metallocene compounds. The examples also include electrically conductive high-molecular compounds such as polyaniline and polythiophene.

Among those mentioned above, particularly a viologen compound expressed by general formula (1) below or a terephthalic acid compound expressed by general formula (2) below is preferable.

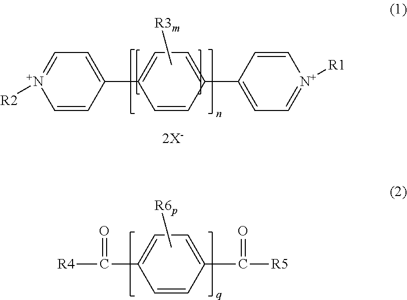

Because such materials have a low color appearance/disappearance potential, they may provide appropriate color values in an electrochromic display apparatus having plural display electrodes.

Preferably, the first and the second electrochromic compounds 16a and 16b may include compounds expressed by general formula (3) below, in which a heterocyclic compound derivative structure is located between two pyridine ring alkyl cation structures. Such materials have high memory characteristics and therefore contribute to increasing image retention time and decreasing power consumption.

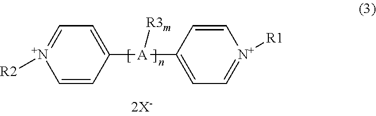

Preferably, the first and the second electrochromic compounds 16a and 16b may include viologen compounds. Preferably, they may include terephthalic acid compounds. Preferably, they may include compounds in which a heterocyclic compound derivative structure is located between two pyridine ring alkyl cation structures. By using materials having similar molecular structures, the first and second display electrodes 13a and 13b may be provided with substantially the same color appearance/disappearance potential, enabling easy control of their color appearance/disappearance using the same electrolyte.

Examples of the electrochromic compounds of the metal complex type and the metal oxide type include inorganic electrochromic compounds such as titanium oxide, vanadium oxide, tungsten oxide, indium oxide, iridium oxide, nickel oxide, and Prussian blue. The material of the metal oxide 17 is not particularly limited. Examples include metal oxides having any of the following as a principal component: titanium oxide, zinc oxide, tin oxide, aluminum oxide (“alumina”), zirconium oxide, cerium oxide, silicon oxide (“silica”), yttrium oxide, boron oxide, magnesium oxide, strontium titanate, potassium titanate, barium titanate, calcium titanate, calcium oxide, ferrite, hafnium oxide, tungsten oxide, iron oxide, copper oxide, nickel oxide, cobalt oxide, barium oxide, strontium oxide, vanadium oxide, aluminum silicate, calcium phosphate, and aluminosilicate. These metal oxides may be used individually or in a mixture of two or more of the aforementioned components.

From the viewpoint of electrical and physical characteristics, such as electrical conductivity and optical property, multicolor display with a high color appearance/disappearance response rate can be achieved by using a compound selected from titanium oxides, zinc oxides, tin oxides, alumina, zirconium oxides, iron oxides, magnesium oxides, indium oxides, and tungsten oxides, or a mixture thereof. In particular, multicolor display with high color appearance/disappearance response rate may be achieved by using a titanium oxide.

The shape of the metal oxide 17 is not particularly limited. Preferably, the shape of the metal oxide 17 is such that its surface area per unit volume (“specific surface area”) is large, so that the metal oxide 17 can support the first and the second electrochromic compounds 16a and 16b efficiently. For example, by forming the metal oxide 17 from an aggregate of nanoparticles, a large specific surface area may be obtained, so that the metal oxide 17 can support the electrochromic compounds efficiently, enabling multicolor display with an improved color appearance/disappearance display contrast ratio.

Further preferably, plural kinds of particles with different particle diameters may be mixed. The presence of particles with different particle diameters provides gaps within the electrochromic layer, whereby improved electrolyte permeability may be obtained. A layer comprising such a mixture of particles with different particle diameters may also have an improved strength against distortion in the layer upon its coating and the like, thus enhancing the yield during the manufacture of the element.

The electrochromic compounds 16a and 16b may be supported on the metal oxide 17 via a mixture layer of the electrochromic compound 16a or 16b and the metal oxide 17. However, in order to improve the color appearance/disappearance display contrast ratio in multicolor display, it is preferable to use a structure such that the electrochromic compound 16a or 16b is adsorbed on the metal oxide 17 via an adsorbing group.

The material of the insulating layer 22 is not particularly limited as long as it is porous and has appropriate insulating property. Preferably, the material is highly durable and has excellent film formation property. Preferably, the material may include ZnS. ZnS provides the advantage that it can be formed into a film on the electrochromic layer 14a quickly by sputtering without damaging the electrochromic layer 14a. Examples of the materials that contain ZnS as a principal component include ZnO—SiO₂, ZnS—SiC, ZnS—Si, and ZnS—Ge, where the content of ZnS may be preferably in a range from about 50 mol % to about 90 mol % so that proper crystalline characteristics can be maintained upon formation of the insulating layer 22. Thus, particularly preferable examples are ZnS—SiO₂(8/2), ZnS—SiO₂(7/3), ZnS, and ZnS—ZnO—In₂O₃—Ga₂O₃(60/23/10/7).

By using such materials in the insulating layer 22 as mentioned above, a proper insulating effect may be obtained from a thin film, and the decrease in the strength of the insulating layer 22 due to the stacking of the multiple layers, which may result in the peeling of the insulating layer 22, may be prevented. A porous film of the insulating layer 22 may be obtained by forming the insulating layer 22 as a particle film. For example, when sputtering ZnS, a porous film of ZnS may be formed by forming a particle film as an undercoat layer in advance. In this case, while the metal oxide 17 may be formed as such a particle film, a porous particle film including silica or alumina, for example, may be formed as a part of the insulating layer 22. By thus forming the insulating layer 22 as a porous film, transmission of the electrolyte 20 through the insulating layer 22 is allowed, thus facilitating the transfer of the ions (charges) within the electrolyte 20 in response to a redox reaction. Accordingly, it becomes possible to provide multicolor display with an improved color appearance/disappearance response rate.

The film thickness of the insulating layer 22 may be preferably in the range from 20 nm to 500 nm and more preferably in the range from 50 nm to 150 nm. If the film thickness is less than the above ranges, required insulation may not be obtained. If the film thickness is more than the above ranges, manufacturing cost may increase and visibility may decrease due to coloration.

Hereafter, materials of the opposite substrate 12 and the opposite electrode 15 formed on the opposite substrate 12 are described. The material of the opposite substrate 12 is not particularly limited. The material of the opposite electrode 15 is not particularly limited either, as long as it is electrically conductive. When the opposite substrate 12 comprises a glass substrate or a plastic film, examples of the material of the opposite electrode 15 include a transparent conductive film of ITO, FTO, or zinc oxide; a conductive metal film of zinc or platinum; and carbon. Such a transparent conductive film or a conductive metal film of the opposite electrode 15 may be coated on the opposite substrate 12. When a metal plate of zinc and the like is used as the opposite substrate 12, the opposite substrate 12 may also function as the opposite electrode 15.

When the material of the opposite electrode 15 is configured to exhibit a reaction opposite to the redox reaction exhibited by the first electrochromic layer 14a or the second electrochromic layer 14b, stable color appearance/disappearance may be achieved. Specifically, when the first and the second electrochromic layers 14a and 14b exhibit colors by oxidation, the material of the opposite electrode 15 may be configured to exhibit a reduction reaction. When the first and the second electrochromic layers 14a and 14b are configured to exhibit colors by reduction, the material of the opposite electrode 15 may be configured to exhibit an oxidation reaction. In this way, the color appearance/disappearance reactions in the first and the second electrochromic layers 14a and 14b may be made more stable.

Hereafter, the materials of the electrolyte 20 and the white reflecting layer 21 are described. Generally, the material of the electrolyte 20 includes a supporting salt dissolved in a solvent. Examples of the supporting salt include inorganic ionic salt such as alkali metal salt and alkaline-earth metal salt; quaternary ammonium salt; acids; and alkalis. Specific examples include LiClO₄, LiBF₄, LiAsF₆, LiPF₆, LiCF₃SO₃, LiCF₃COO, KCl, NaClO₃, NaCl, NaBF₄, NaSCN, KBF₄, Mg(ClO₄)₂, and Mg(BF₄)₂. Examples of the solvent include propylene carbonate, acetonitrile, γ-butyrolactone, ethylene carbonate, sulfolane, dioxolan, tetrahydrofuran, 2-methyltetrahydrofuran, dimethylsulfoxide, 1,2-dimethoxyethane, 1,2-ethoxymethoxyethane, polyethyleneglycol, and alcohols. The material of the electrolyte 20 is not limited to a liquid electrolyte comprising a supporting salt dissolved in a solvent. Preferably, the electrolyte 20 may include an electrolyte in gel form, or a solid electrolyte such as a polymer electrolyte.

Examples of the material of the white pigment particles contained in the white reflecting layer 21 include titanium oxide, aluminum oxide, zinc oxide, silica, oxidation cesium, and yttrium oxide. By mixing particles having a light-storing property in the pigment particles, the brightness of the reflecting layer 21 can be improved by external light energy, so that brighter display can be performed. Thus, the white reflecting layer 21 may preferably include a material having a light-storing property. The white reflecting layer 21 may improve reflection contrast and visibility. As will be described with reference to a fourth variation of the first embodiment, the function of the white reflecting layer can be provided by mixing white pigment particles in a polymer electrolyte.

Thus, in accordance with the present embodiment, the potentials of the first and the second display electrodes 13a and 13b in the electrochromic display apparatus 10 are independently controlled, so that the first and the second electrochromic layers 14a and 14b can be independently caused to perform color appearance/disappearance. Thus, an electrochromic display apparatus can be provided in which desired colors can be exhibited by a simple control process.

The organic polymer material of the aforementioned protection layer formed on the first and/or the second electrochromic layer 14a and 14b may be selected from conventional resins from the viewpoint of close adhesion to the electrochromic layer 14. Examples of such resins include polyvinyl alcohol, poly-N-vinyl amide, polyester, polystyrene, and polypropylene.

### Variation 1

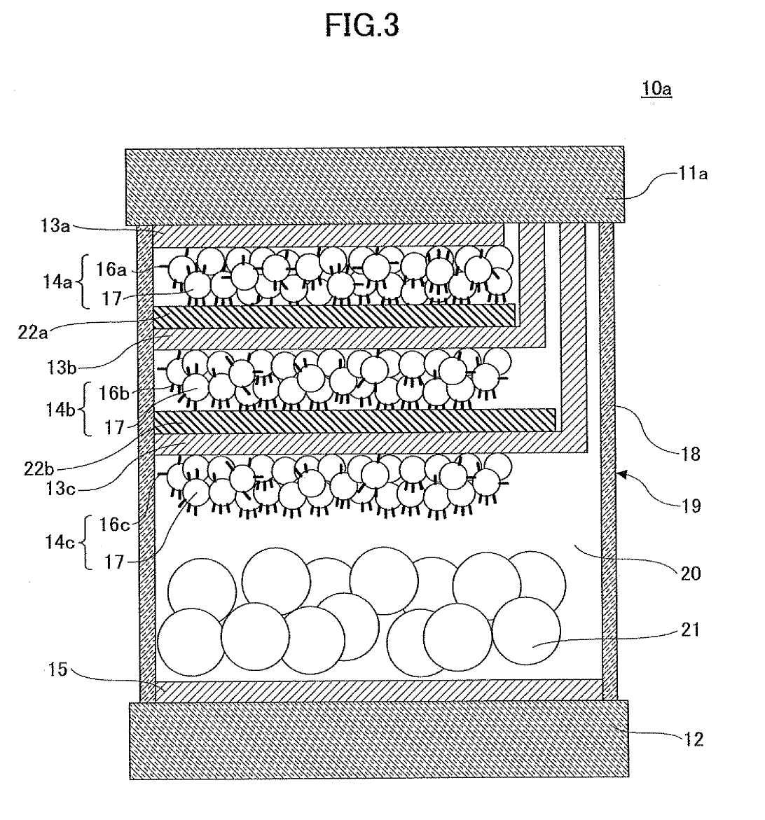

With reference to FIG. 3, a first variation of Embodiment 1 is described. FIG. 3 is a schematic cross section of an electrochromic display apparatus 10a according to Variation 1. The electrochromic display apparatus 10a differs from the electrochromic display apparatus 10 according to Embodiment 1 in that it includes three display electrode layers and three electrochromic layers.

As illustrated in FIG. 3, the electrochromic display apparatus 10a includes a display substrate 11a; a first display electrode 13a formed on the display substrate 11a; a first electrochromic layer 14a disposed on the first display electrode 13a; a first insulating layer 22a disposed on the first electrochromic layer 14a; a second display electrode 13b disposed on the first insulating layer 22a; a second electrochromic layer 14b disposed on the second display electrode 13b; a second insulating layer 22b disposed on the second electrochromic layer 14b; a third display electrode 13c disposed on the second insulating layer 22b; and a third electrochromic layer 14c disposed on the third display electrode 13c.

Such a structure of the electrochromic display apparatus 10a readily enables multicolor display. Because the first, second, and third display electrodes 13a, 13b, and 13c are isolated from one another by the first and second insulating layers 22a and 22b, the potentials between the first, the second, and the third display electrodes 13a, 13b, and 13c and the opposite electrode 15 can be independently controlled. As a result, the first, second, and third electrochromic layers 14a, 14b, and 14c disposed on the first, second, and third display electrodes 13a, 13b, and 13c, respectively, can be independently caused to perform color appearance/disappearance. Because the first, second, and third electrochromic layers 14a, 14b, and 14c are layered on the display substrate 11a, various patterns of color appearance/disappearance may be realized, thus providing multicolor display.

For example, 1) the first, second, or third electrochromic layer 14a, 14b, or 14c may be caused to exhibit color; 2) the first and second electrochromic layers 14a and 14b may be caused to exhibit colors; 3) the first and third electrochromic layers 14a and 14c may be caused to exhibit colors; 4) the second and third electrochromic layers 14b and 14c may be caused to exhibit colors; and 5) all of the first, second, and third electrochromic layers 14a, 14b, and 14c may be caused to exhibit colors.

Preferably, the first, second, and third electrochromic layers 14a, 14b, and 14c may be configured to exhibit colors of yellow, magenta, and cyan, respectively. In this way, the electrochromic display apparatus 10a can perform full-color display by controlling the potentials of the first, second, and third display electrodes 13a, 13b, and 13c independently.

Thus, in accordance with the present variation of Embodiment 1, the electrochromic display apparatus 10a can exhibit various colors by a simple control operation.

### Variation 2

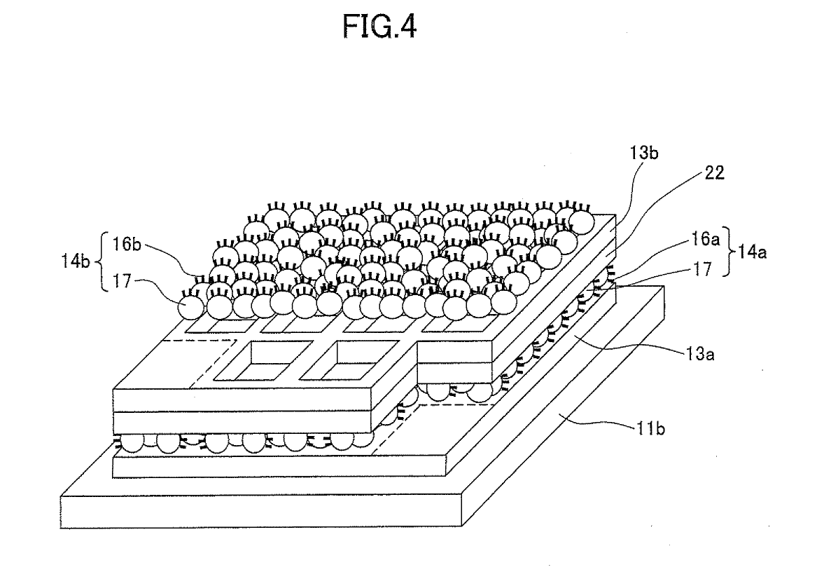

With reference to FIG. 4, a second variation of Embodiment 1 is described. FIG. 4 is a schematic perspective view of a display substrate 11b of an electrochromic display apparatus according to Variation 2. The electrochromic display apparatus of Variation 2 differs from the electrochromic display apparatus 10 of Variation 1 in that the second display electrode 13b has a meshed lattice structure in a plan view. The structure is in contrast to Embodiment 1 in which the second display electrode 13b is formed on the entire surface of the display substrate 11.

The meshed lattice structure of the second display electrode 13b facilitates the transfer of ions (charges) within the electrolyte 20 in response to a redox reaction, so that the color appearance/disappearance response rate of multicolor display can be improved. Thus, in accordance with Variation 2 of Embodiment 1, the electrochromic display apparatus can perform multicolor display based on a simple control operation at high speed.

### Variation 3

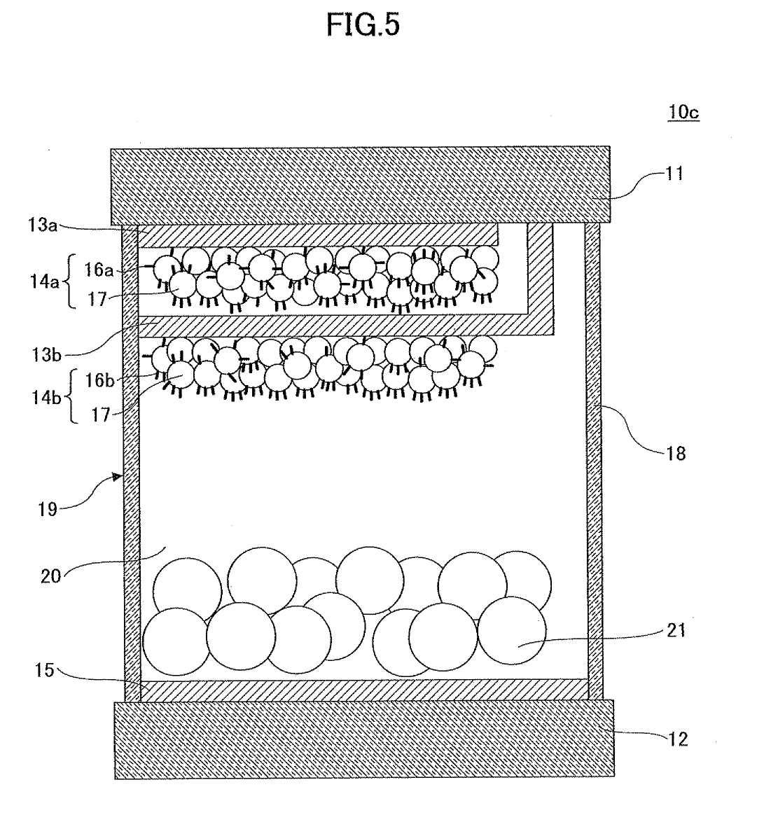

Next, a third variation of Embodiment 1 is described with reference to FIG. 5. FIG. 5 is a schematic cross section of an electrochromic display apparatus 10c according to Variation 3. The electrochromic display apparatus 10c differs from the electrochromic display apparatus 10 of Embodiment 1 in that the insulating film 22 is not provided.

Referring to FIG. 5, in accordance with Variation 3, in the electrochromic display apparatus 10c, the first electrochromic layer 14a disposed on the first display electrode 13a is substantially isolated from the second display electrode 13b without placing an insulating layer between them. By controlling the resistance of the first electrochromic layer 14a, the inter-electrode resistance between the first and second display electrodes 13a and 13b can be set higher than the sheet resistance of either display electrode.

Thus, the potentials of the first and second display electrodes 13a and 13b can be independently controlled without providing the insulating layer 22. Because the first and second electrochromic layers 14a and 14b can be independently caused to perform color appearance/disappearance, the electrochromic display apparatus 10c can exhibit various colors by a simple control operation.

### Variation 4

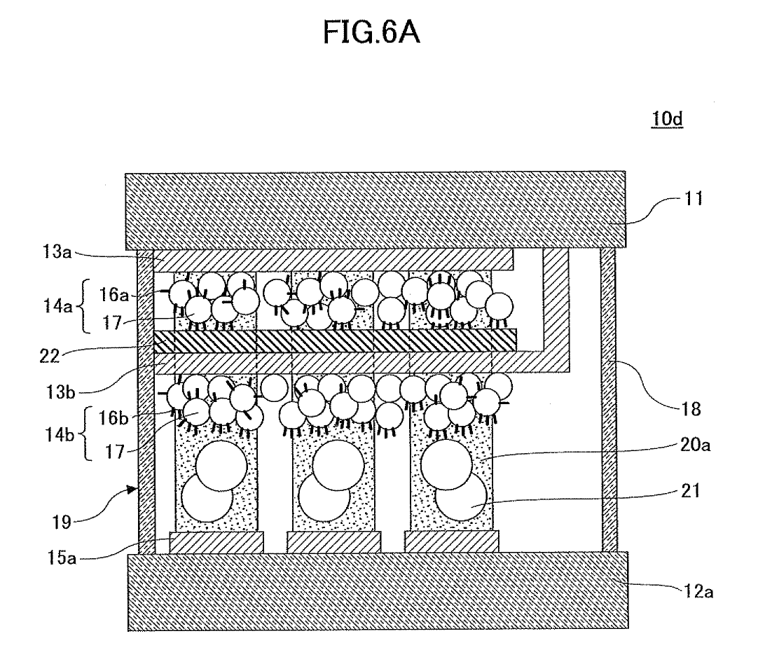

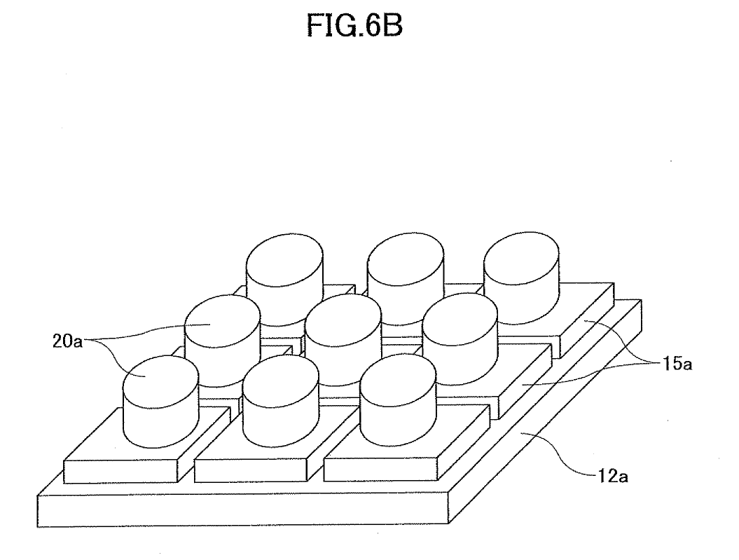

With reference to FIGS. 6A and 6B, an electrochromic display apparatus 10d according to a fourth variation of Embodiment 1 is described. FIG. 6A is a schematic cross section of the electrochromic display apparatus 10d. FIG. 6B is a schematic perspective view of the opposite substrate 12a of the electrochromic display apparatus 10d.

The electrochromic display apparatus 10d differs from the electrochromic display apparatus 10 of Embodiment 1 in that an electrolyte 20a is patterned in the form of a matrix. Preferably, the white reflecting layer 21 may also be similarly patterned. In this case, the white reflecting layer 21 may be layered on the patterned electrolyte 20a. Alternatively, as illustrated in FIG. 6A, the white reflecting layer 21 may be mixed with the electrolyte 20a.

The electrolyte 20a may be patterned by various methods. In one example, the electrolyte 20a may be patterned by mixing the electrolyte 20a with a solvent and a transparent ink or a white ink, and then applying the mixture according to a predetermined pattern using an inkjet method or a screen printing method. Such inks may include a conventional UV-curable ink or a heat-curable ink. In order to retain the electrolyte 20a or the solvent, a material having a low-density structure with a low cross linking ratio may be used.

The electrolyte 20a may include a polymer electrolyte. In this case, the insulating layer 22 may include the electrolyte 20a including the polymer electrolyte. Generally, patterning the plural display electrodes and electrochromic layers into a matrix shape leads to an excessive increase in manufacturing cost. Such an increase in manufacturing cost can be prevented by the simple method of application of the electrolyte 20a according to the present embodiment, whereby a polymer electrolyte is applied in a predetermined matrix pattern.

When the electrolyte 20a is patterned into a matrix shape as illustrated in FIGS. 6A and 6B, the opposite electrode 15a may also be patterned so that the voltages between the electrolyte 20a and the respective display electrodes can be independently controlled.

Preferably, the electrolyte 20a may be patterned in association with pixel electrodes, whereby individual pixels can be independently driven by an active matrix without patterning the plural display electrodes or plural electrochromic layers, as will be described later with reference to Embodiment 2.

### Method of Manufacturing the Electrochromic Display Apparatus According to Embodiment 1

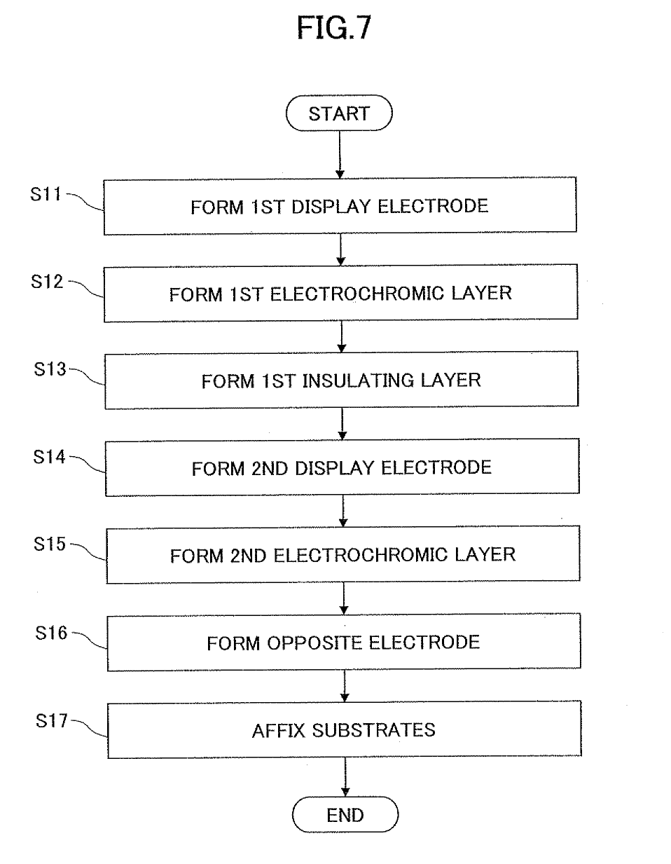

A method of manufacturing the electrochromic display apparatus 10 according to Embodiment 1 is described with reference to a flowchart of FIG. 7.

### Formation of 1st Display Electrode

In step S11, the first display electrode 13a is formed on the display substrate 11 by a vacuum film forming technology, such as vapor deposition, sputtering, or ion plating, for example.

### Formation of 1st Electrochromic Layer

In step S12, the first electrochromic layer 14a including the first electrochromic compound 16a and the metal oxide particles 17 is formed on the first display electrode 13a by spin coating or screen printing, for example. Specifically, a liquid coating ink may be prepared by dispersing or dissolving metal oxide particles 17 and the electrochromic compound 16a in a solvent, and then the coating ink may be applied to the first display electrode 13a by spin-coating, thereby forming the first electrochromic layer 14a. Alternatively, the coating ink may be applied to the display substrate 11 by screen-printing, thereby forming the first electrochromic layer 14a.

The solvent for adjusting the coating ink may include various known solvents (such as water, alcohol, cellosolve, halogenated carbon, ketone, and ether). The first electrochromic layer 14a may be coated by applying a coating ink mixture of the electrochromic compound 16a and the metal oxide particles 17 in one batch. Alternatively, the first electrochromic layer 14a may be coated by applying a dispersion liquid of the metal oxide particles 17, and then applying the electrochromic compound 16a on the layer of the metal oxide particles 17.

### Formation of the First Insulating Layer

In step S13 of FIG. 7, the first insulating layer 22 is formed on the first electrochromic layer 14a by a vacuum film forming method, such as vapor deposition, sputtering, and ion plating.

### Formation of the 2nd Display Electrode and Electrochromic Layer

In steps S14 and S15, the second display electrode 13b and the second electrochromic layer 14b are formed. Steps S14 and S15 may be performed similarly to steps S11 and S12.

### Formation of the Opposite Electrode

In Step S16, the opposite electrode 15 is formed on the opposite substrate 12 by a vacuum film forming method, such as vapor deposition, sputtering, and ion plating.

### Fixing of Substrates

In step S17, the opposite substrate 12, on which the opposite electrode 15 is formed, is fixed to the display substrate 11, on which the various layers are formed up to and including the first insulating layer 22, via the electrolyte 20 containing particles for the white reflecting layer 21. Specifically, the display substrate 11 and the opposite substrate 12 are fixed to each other via the spacer 18, forming the cell 19. The cell 19 is then vacuum-injected with the electrolyte solution 20 containing the particles for the white reflecting layer 21 via an opening (not shown) in the cell 19. The opening is then hermetically sealed. The white reflecting layer 21 may be formed by applying a resin dispersion of white pigment particles onto the opposite electrode 15.

Alternatively, a polymer electrolyte and a UV curable ink may be mixed, and the mixture may be applied onto the display substrate 11 or the opposite substrate 12 in accordance with a predetermined pattern by screen printing or inkjet printing. The display substrate 11 and the opposite substrate 12 are then fixed to each other such that their electrodes are facing each other. The space between the substrates is then filled with an electrolyte solution, and the UV curable ink is then irradiated with UV light, thereby curing the UV curable ink and fixing the display substrate and the opposite substrate to each other.

### Embodiment 2

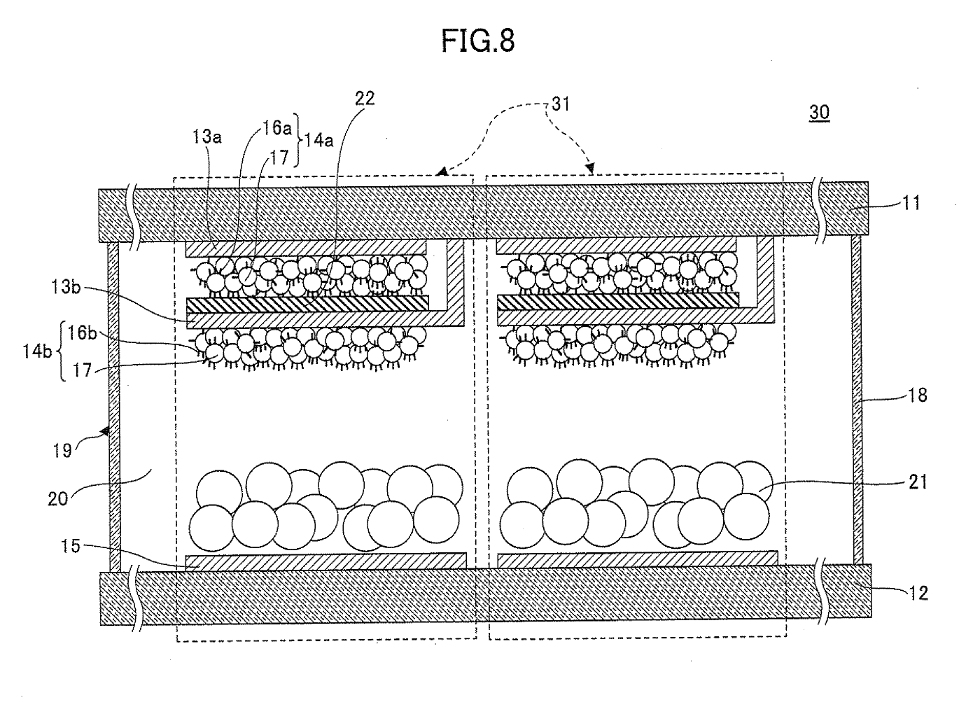

With reference to FIGS. 8 through 10, an image display apparatus 30 according to another embodiment of the present invention is described. The image display apparatus 30 includes the electrochromic display apparatus 10 according to Embodiment 1. Specifically, the image display apparatus 30 includes plural the electrochromic display apparatuses 10 and uses them as electrochromic display elements 31 for displaying individual pixels. The electrochromic display elements 31 can retain a color-exhibiting state or a color-off state for a long time, enabling the image display apparatus 30 to retain an image-displayed state or a non-image-displayed state for a long time.

The image display apparatus 30 may be used as a reflecting-type display apparatus, such as an electronic paper.

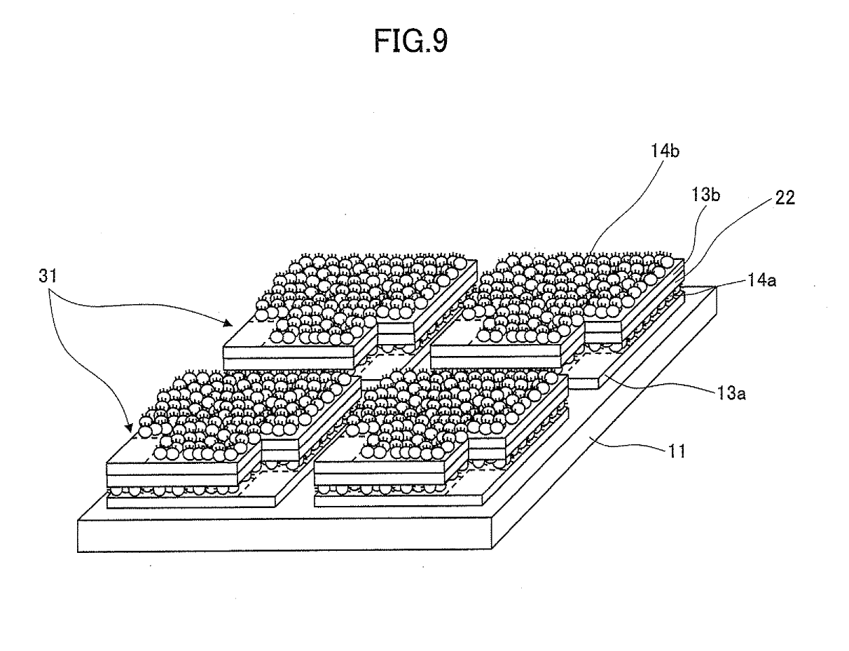

FIG. 8 is a schematic cross section of the image display apparatus 30. The image display apparatus 30 includes a display substrate 11 and an opposite substrate 12. FIG. 9 is a schematic perspective view of the display substrate 11. On the opposite substrate 12, plural opposite electrodes 15 are provided for the respective electrochromic display elements 31. On the display substrate 11, there are disposed first display electrodes 13a, first electrochromic layers 14a, insulating films 22, second display electrodes 13b, and second electrochromic layers 14b for the respective electrochromic display elements 31. Each electrochromic display element 31 includes one set of the first display electrode 13a, the first electrochromic layer 14a, the insulating film 22, the second display electrode 13b, and the second electrochromic layer 14b. The plural electrochromic display elements 31 are disposed within the plane of the display substrate 11 in a matrix form.

The image display apparatus 30 includes the white reflecting layer 21 in the cell 19. The white reflecting layer 21 may be formed by injecting an electrolyte 20 having white pigment particles dispersed therein into the cell 19. Alternatively, the white reflecting layer 21 may be formed by applying a resin dispersion of white pigment particles onto the opposite electrode 15. Further preferably, a polymer electrolyte may be formed in a pattern in accordance with the matrix electrode shape, as mentioned above. This last method may be more advantageous in terms of manufacturing cost.

Hereafter, a method for driving the electrochromic display elements 31 of the image display apparatus 30 is described. Various units or circuits may be employed for applying an electric field to the electrochromic display elements 31 of the image display apparatus 30. For example, a known active-matrix driving electric circuit may be adopted to drive the electrochromic display elements 31 according to a known active-matrix drive method. The active-matrix driving electric circuit may include an electric circuit in which electrodes of thin-film transistors (TFT) as active matrix drive elements are connected to the electrochromic display element 31. This type of electric circuit can drive the individual electrochromic display elements 31 at high speed, thereby enabling the image display apparatus 30 to display a fine-resolution image at high speed.

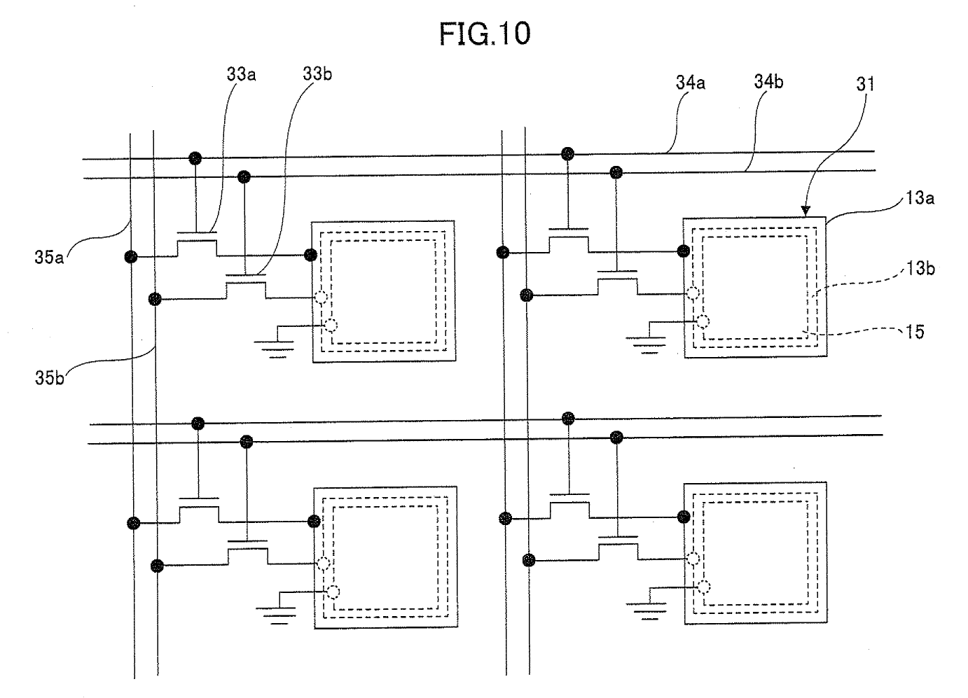

Next, a drive circuit for driving the electrochromic display elements 31 of the image display apparatus 30 using an active matrix drive method is described with reference to FIG. 10. As illustrated in FIG. 10, the image display apparatus 30 includes the plural electrochromic display elements 31; thin-film transistors 33a and 33b connected to the first and the second display electrodes 13a and 13b, respectively, of the plural electrochromic display elements 31; lead wires 34a and 34b disposed in the horizontal direction and connected to the gate electrodes of the thin-film transistors 33a and 33b; and lead wires 35a and 35b disposed in the vertical direction and connected to the source electrodes of the thin-film transistors 33a and 33b. The drain electrodes of the thin-film transistors 33a are connected to the first display electrodes 13a of the electrochromic display elements 31. The drain electrodes of the thin-film transistors 33b are connected to the second display electrodes 13b of the electrochromic display elements 31. The opposite electrodes 15 of the electrochromic display elements 31 have a constant potential, such as ground potential.

In the image display apparatus 30 illustrated in FIG. 10, when a voltage is applied across one of the lead wires 34a in the horizontal direction and one of the lead wires 35a in the vertical direction, the voltage is applied to the gate electrode of the thin-film transistor 33a connected to the selected lead wires 34a and 35a, whereby the thin-film transistor 33a turns on and the resistance between its source and drain electrodes decreases. As a result, a voltage is applied to the first display electrode 13a of the electrochromic display element 31 connected to the thin-film transistor 33a. This causes the first electrochromic compound contained in the electrochromic display element 31 to exhibit a predetermined color.

Similarly, when a voltage is applied to one of the lead wires 34b in the horizontal direction and one of the lead wires 35b in the vertical direction, a voltage is applied across the selected second display electrode 13b and the selected opposite electrode 15. This causes the second electrochromic compound contained in the corresponding electrochromic display element 31 to exhibit a predetermined color. By these operations, the pixel located between the selected display electrode and the selected opposite electrode can be caused to exhibit a color due to the first electrochromic compound alone, a color due to the second electrochromic compound alone, or a color due to both the first and second electrochromic compounds.

Thus, by selectively applying voltages between the first and/or the second display electrode 13a and 13b and the opposite electrode 15, the image display apparatus 30 can display a desired image.

In order to retain the exhibited color for an extended duration of time, there should be no low-resistance portion between the selected display electrode and the other display electrode or the opposite electrode. Namely, the selected display electrode should be electrically insulated from the other electrodes. Such an electrical insulation makes it possible to prevent the discharge of the charges from the electrochromic compound via the electrodes or the low-resistance portion, or the injection of the charges discharged from the electrochromic compound via the low-resistance portion or electrodes. In this way, the color retention time can be improved.

Preferably, when the display electrodes are caused to exhibit colors, a color-eliminating voltage may be initially applied to each display electrode and then the electrochromic layers may be caused to exhibit colors by the above-described color-exhibiting drive method, one layer at a time. Such an application of a color-eliminating voltage to the display electrode enables the charge state (oxidoreduction reaction state) of the electrochromic compound to be initialized. Thereafter, a color may be caused to appear on a layer by layer basis. In this way, the color appearance/disappearance operation of the individual electrochromic layers can be controlled with high reproducibility.

The oxidoreduction reaction state of each electrochromic layer may be controlled to be an intermediate state between an oxidized state where all of the electrochromic particles are completely oxidized and a reduced state where all of the electrochromic particles are completely reduced. Such an intermediate state enables the electrochromic layers to exhibit an intermediate color between a color-exhibited state and a color-off state.

The electrochromic layers may be controlled to be in the intermediate state by controlling the product of the voltage applied to the display electrode corresponding to the particular electrochromic layer and time (i.e., by controlling the amount of charges injected or emitted). In this case, the intermediate color may be controlled by continuously varying the applied voltage and time. Alternatively, the intermediate color may be controlled by varying the number of times of application of a voltage pulse having a predetermined maximum voltage value and a predetermined pulse width.

Thus, in accordance with Embodiment 2 of the present invention, the stacked layers of the display electrodes and the electrochromic layers are disposed in a matrix form within the plane of the substrate of the image display apparatus 30, so that the image display apparatus 30 can display various images.

The thin-film transistors 33a and 33b connected to the first display electrode 13a and the second display electrode 13b, respectively, on the display substrate 11 may be formed on the opposite substrate 12 so that the thin-film transistors 33a and 33b do not reduce the visibility of the colors exhibited by the electrochromic display element 31.

While the image display apparatus 30 has been described as including two display electrodes and two electrochromic layers disposed on the display electrodes, the number of layers of the display electrode and/or electrochromic layers may be three or more.

### Example 1

### Formation of Display Electrode and Electrochromic Layer

A glass substrate measuring 30 mm×30 mm was prepared, and then an ITO film was formed in an area of 16 mm×23 mm on an upper surface of the glass substrate by sputtering, to a thickness of about 100 nm, thereby forming a first display electrode. The first display electrode had a sheet resistance of about 200Ω across its electrode ends.

The glass substrate with the first display electrode formed thereon was coated with SP210 (available from Showa Titanium Co., Ltd.) as a titanium oxide nanoparticle dispersion liquid by spin coating, followed by annealing at 120° C. for 15 minutes (min), thereby forming a titanium oxide particle film. Thereafter, a coating liquid was prepared by mixing a 5 wt % 2,2,3,3-tetrafluoropropanol solution of a viologen compound according to General formula (4) below and the aforementioned SP210, to a ratio of 2.4/4.

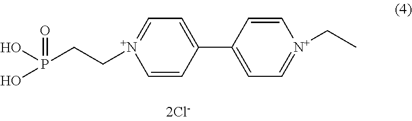

The coating liquid was applied to the glass substrate by spin coating, followed by annealing at 120° C. for 10 min, thereby forming a first electrochromic layer including titanium oxide particles and the electrochromic compound.

Then, on the glass substrate with the first electrochromic layer formed thereon, a 0.1 wt % ethanol solution of poly-N-vinyl amide and a 0.5 wt % aqueous solution of polyvinyl alcohol were applied by spin coating, forming a protection layer. This was followed by the formation of an inorganic insulating layer by forming a film of ZnS—SiO₂ with the composition ratio of 8/2 by sputtering to a film thickness in a range from 25 nm to 150 nm. Further, in a 10 mm×20 mm area of the inorganic insulating layer on the surface of the glass substrate, an ITO film of ZnS—SiO₂ was formed by sputtering to a thickness of about 100 nm, thereby forming a second display electrode. The sheet resistance of the second display electrode across its ends was about 200 Ω.

On the glass substrate with the second display electrode formed thereon, there was further applied SP210 (Showa Titanium Co., Ltd.) as a titanium oxide nanoparticle dispersion liquid by spin coating, followed by annealing at 120° C. for 15 min, forming a titanium oxide particle film.

A coating liquid was prepared by mixing a 1 wt % 2, 2, 3, 3-tetrafluoropropanol solution of a viologen compound expressed by General Formula (5) below and the SP210 to the ratio of 2.4/4.

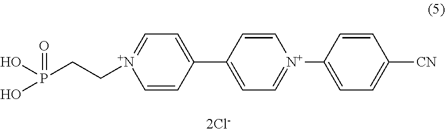

The coating liquid was applied by spin coating and then annealed at 120° C. for 10 min, thereby forming a second electrochromic layer containing titanium oxide particles and the electrochromic compound and thus completing the display substrate.

### Formation of Opposite Electrode

Separately from the above glass substrate, a glass substrate measuring 30 mm×30 mm was prepared, and a transparent conductive thin-film of tin oxide was formed on an entire upper surface of the glass substrate. A solution was prepared by adding 25 wt % of 2-ethoxyethyl acetate to CH10 (available from Jujo Chemical Co., Ltd.) as a thermosetting conductive carbon ink. The solution was then applied to an upper surface of the glass substrate, with the transparent conductive thin-film of tin oxide formed thereon by spin coating. This was followed by annealing at 120° C. for 15 min, completing the opposite substrate.

### Assembly of an Electrochromic Display Apparatus

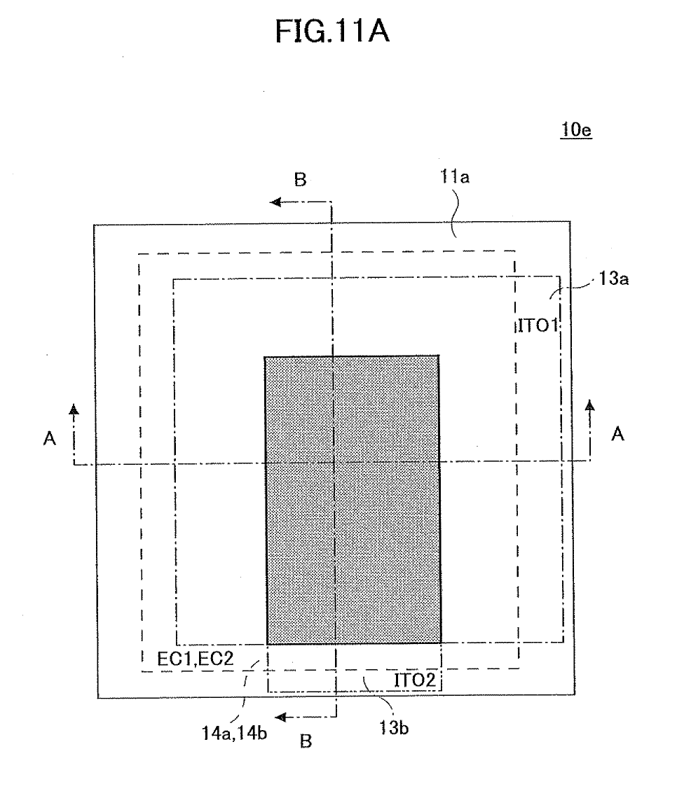

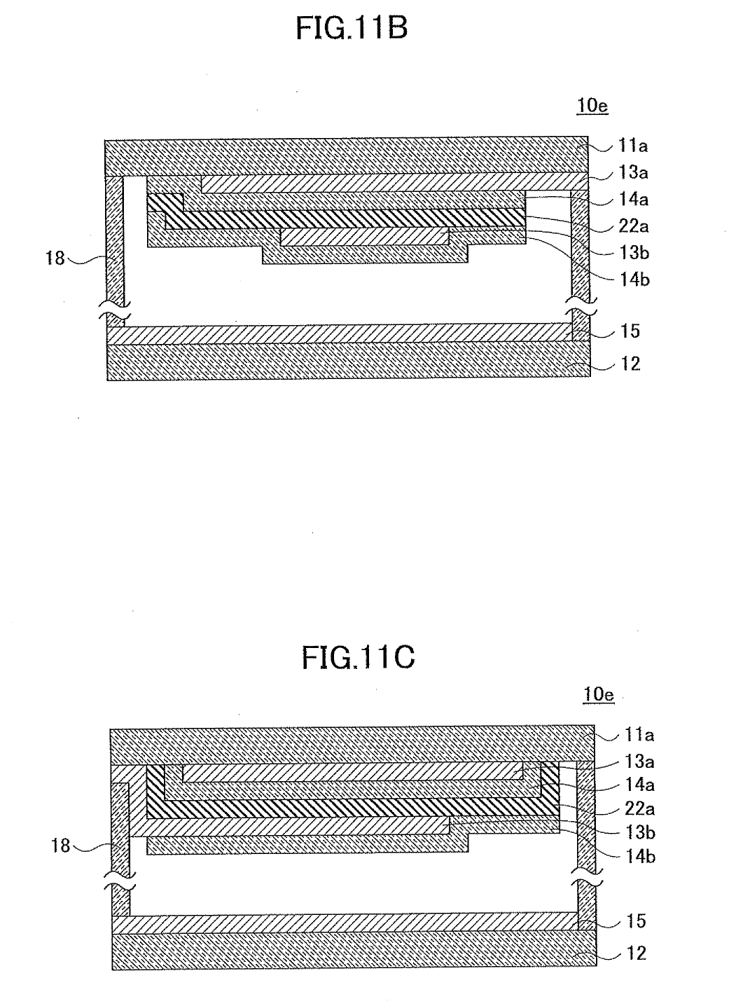

The display substrate and the opposite substrate were fixed to each other via spacers with a length of 75 μm, thereby forming a cell. An electrolyte solution was prepared by dispersing 35 wt % of titanium oxide particles (manufactured by Ishihara Sangyo Kaisha, Ltd.) having a primary particle diameter of 300 nm in a propylene carbonate solution in which 0.1 M of perchlorate chloride had been dissolved. The electrolyte solution was put into the cell in a hermetically sealed manner, obtaining the electrochromic display apparatus 10e illustrated in FIG. 11.

FIGS. 11A, 11B, and 11C illustrate the electrochromic display apparatus 10e according to Example 1. FIGS. 11A, 11B and 11C are a plan view, a cross section taken along line A-A of FIG. 11A, and a cross section taken along line B-B of FIG. 11A, respectively, of the electrochromic display apparatus 10e.

Referring to FIGS. 11B and 11C, the electrochromic display apparatus 10e includes the first display electrode 13a (ITO1), the first electrochromic layer 14a (EC1), the insulating layer 22a, the second display electrode 13b (ITO2), and the second electrochromic layer 14b (EC2). As illustrated in FIG. 11A, the electrochromic display apparatus 10e has a central area (with hatching) in which all of ITO1, EC1, ITO2, and EC2 are layered. This central area with hatching is hereafter referred to as a color appearance/disappearance evaluation area that is used for a color appearance/disappearance test, which will be described below.

### Measurement of Inter-Electrode Resistance

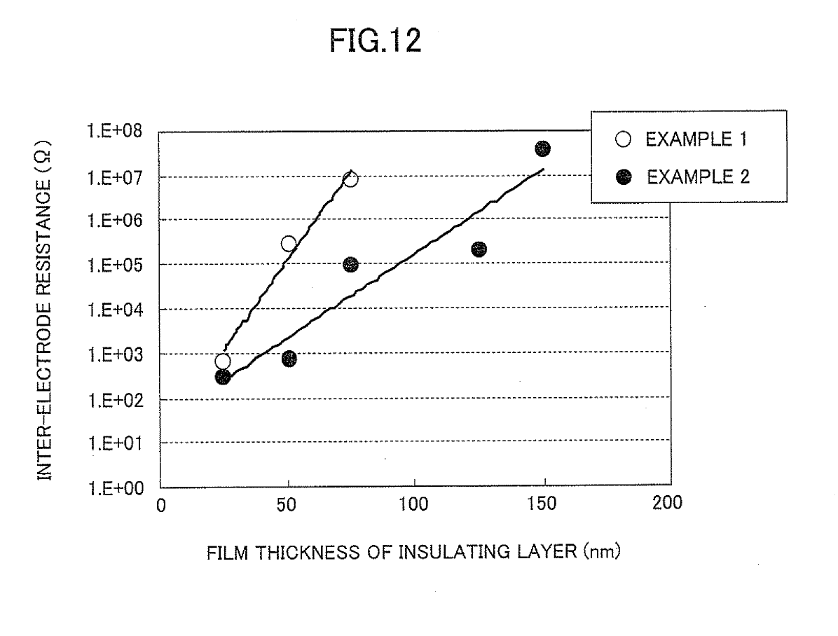

The inter-electrode resistance between the first and second display electrodes 13a and 13b of the electrochromic display apparatus 10e according to Example 1 was measured. FIG. 12 is a graph of the measurement results. As may be seen from the graph of FIG. 12, a good insulation of 100 kΩ or more (which is about 500 times more than that of the sheet resistance across the ends of a display electrode) was obtained by making the film thickness of the inorganic insulating layer 50 nm or more.

### Color Appearance/Disappearance Test

A color appearance evaluation was conducted by applying a voltage to the electrochromic display apparatus 10e according to Example 1 with varying film thicknesses of the inorganic insulating layer. The voltage was 1.7 V, which was applied for two s (seconds). The display electrodes were connected to the negative pole and the opposite electrode was connected to the positive pole.

When the film thickness of the inorganic insulating layer was 50 nm or more and the inter-electrode resistance was 100 kΩ or more, blue appeared from the first display electrode or green appeared from the second display electrode independently upon application of the voltage to the first or the second display electrode. Further, the color that had been exhibited could be stably retained.

When the film thickness of the inorganic insulating layer was less than 50 nm and the inter-electrode resistance was less than 100 kΩ, when the voltage was applied to the first display electrode, although the first display electrode exhibited a color independently during the initial period of color appearance, the second display electrode gradually started to exhibit a color over time, thus preventing the color that had been once independently exhibited from being stably retained.

### Example 2

An electrochromic display apparatus (not illustrated) according to Example 2 was prepared in the same way as Example 1 with the exception that the formation of the titanium oxide particle film was omitted. The inter-electrode resistance between the first and second display electrodes of the electrochromic display apparatus was measured. FIG. 12 illustrates the measurement results. As may be seen from FIG. 12, good insulation of 100 kΩ or more (which is about 500 times the sheet resistance across the ends of the display electrode) was obtained by setting the film thickness of the inorganic insulating layer to be 75 nm or more.

### Color Appearance/Disappearance Test

A color appearance/disappearance evaluation was conducted by applying a voltage to the electrochromic display apparatus according to Example 2 with varying film thicknesses of the inorganic insulating layer, as in Example 1. Specifically, the voltage applied was 1.7 V and the duration was 2 s. The display electrodes were connected to the negative electrode and the opposite electrode was connected to the positive electrode.

When the film thickness of the inorganic insulating layer was 75 nm or more and the inter-electrode resistance was 100 kΩ or more, blue appeared from the first display electrode or green appeared from the second display electrode independently upon application of the voltage to the first or the second display electrode. The color that had been independently exhibited could be retained stably.

When the film thickness of the inorganic insulating layer was less than 75 nm and the inter-electrode resistance was less than 100 kΩ, when the voltage was applied to the first display electrode, although the first display electrode exhibited a color independently in the initial period of color appearance, the second display electrode gradually started to exhibit its own color over time, thus preventing the color that had once been independently exhibited from being stably retained.

### Example 3

Two electrochromic display apparatuses (not illustrated) according to Examples 3 were manufactured in the same way as in Example 2 with the exception that the material of the inorganic insulating layer of one apparatus included ZnS and that of the other apparatus ZnO—ZnO—In₂O₃—Ga₂O₃(60/23/10/7), and that the film thickness of the inorganic insulating layer was 140 nm.

The inter-electrode resistance between the first and second display electrodes of the electrochromic display apparatuses was measured. As a result, good insulation of about 10 MΩ was obtained in both the electrochromic display apparatuses.

### Example 4

An electrochromic display apparatus (not illustrated) was manufactured in the same way as in Example 1 with the exception that the display electrodes and the electrochromic layers were manufactured by the following procedure.

### Manufacture of Electrochromic Display Apparatus

A glass substrate measuring 30 mm×30 mm was prepared. An ITO film was formed in a 16 mm×23 mm area on an upper surface of the glass substrate by sputtering to a thickness of about 100 nm, thereby forming the first display electrode. The sheet resistance across the ends of the first display electrode was about 200 Ω.

The glass substrate with the first display electrode formed thereon was coated with SP210 (Showa Titanium Co., Ltd.) as a titanium oxide nanoparticle dispersion liquid by spin coating, followed by annealing at 120° C. for 15 min, thereby forming a titanium oxide particle film. The glass substrate was further coated with a coating liquid by spin coating. The coating liquid included a 1 wt % 2,2,3,3-tetrafluoropropanol solution of a viologen compound expressed by General Formula (5). Thereafter, annealing was performed at 120° C. for 10 min, forming the first electrochromic layer containing titanium oxide particles and the electrochromic compound.

On the glass substrate with the first electrochromic layer formed thereon, there was formed a film of ZnS—SiO₂ (composition ratio 8/2) by sputtering to a film thickness of 140 nm, thereby forming an inorganic insulating layer. Further, an ITO film was formed in a 10 mm×20 mm area on the surface of the glass substrate by sputtering to a thickness of about 100 nm, thus forming the second display electrode. The sheet resistance across the ends of the second display electrode was about 200 Ω.

To the glass substrate with the second display electrode formed thereon, there was further applied SP210 (Showa Titanium Co., Ltd.) as a titanium oxide nanoparticle dispersion liquid by spin coating, and then annealing was performed at 120° C. for 15 min, thus forming a titanium oxide particle film. The glass substrate was further coated with a coating liquid by spin coating, the coating liquid comprising a 1 wt % 2,2,3,3-tetrafluoropropanol solution of the viologen compound expressed by General Formula (4). Then, annealing was performed at 120° C. for 10 min, thereby forming the second electrochromic layer including titanium oxide particles and the electrochromic compound and completing the display substrate. Thereafter, similar steps to those described with reference to Example 2 were performed, obtaining the electrochromic display apparatus.

### Measurement of Inter-Electrode Resistance

The inter-electrode resistance between the first and the second display electrodes of the electrochromic display apparatus was about 10 MΩ, indicating good insulation.

### Color Appearance/Disappearance Test

The electrochromic display apparatus according to Example 4 was subjected to a color appearance/disappearance evaluation in the same way as in Example 2. The color appearance/disappearance evaluation involved irradiation with diffuse light using the LCD-5000 spectrophotometer manufactured by Otsuka Electronics Co., Ltd. For voltage application, the FG-02 function generator (Toho Giken) was used. The voltage applied was 2.55 V and the duration of application was 100 ms, with the pulse interval of 10 ms when multiple pulses were applied.

The electrochromic display apparatus according to Example 4 appeared white without application of voltage, exhibiting a high white reflectivity of about 50%. When the first display electrode was connected to the negative electrode and the opposite electrode was connected to the positive electrode, the electrochromic display apparatus appeared green upon application of the pulse voltage. When the second display electrode was connected to the negative electrode and the opposite electrode was connected to the positive electrode, the electrochromic display apparatus appeared blue upon application of the pulse voltage. Further, when the first and the second display electrodes were connected to the negative electrode and the opposite electrode was connected to the positive electrode, the electrochromic display apparatus 10i appeared black upon application of the pulse voltage.

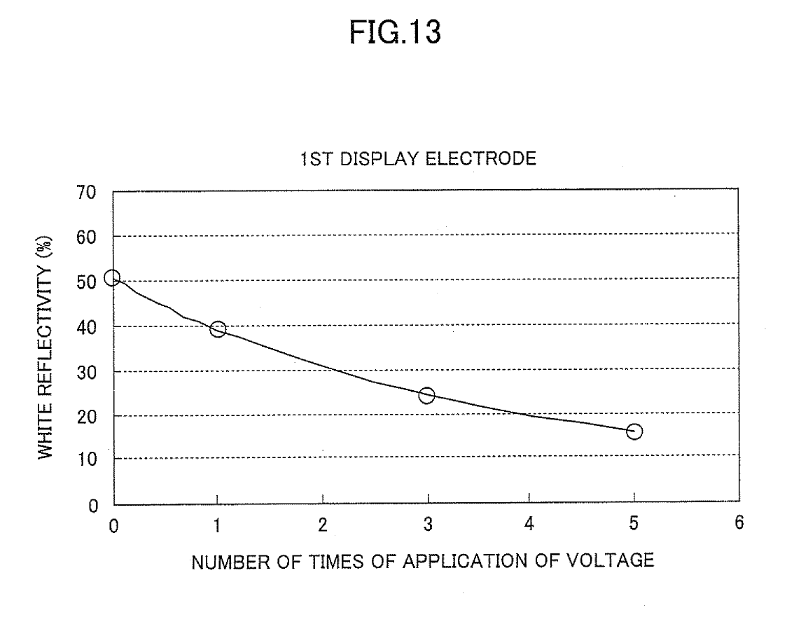

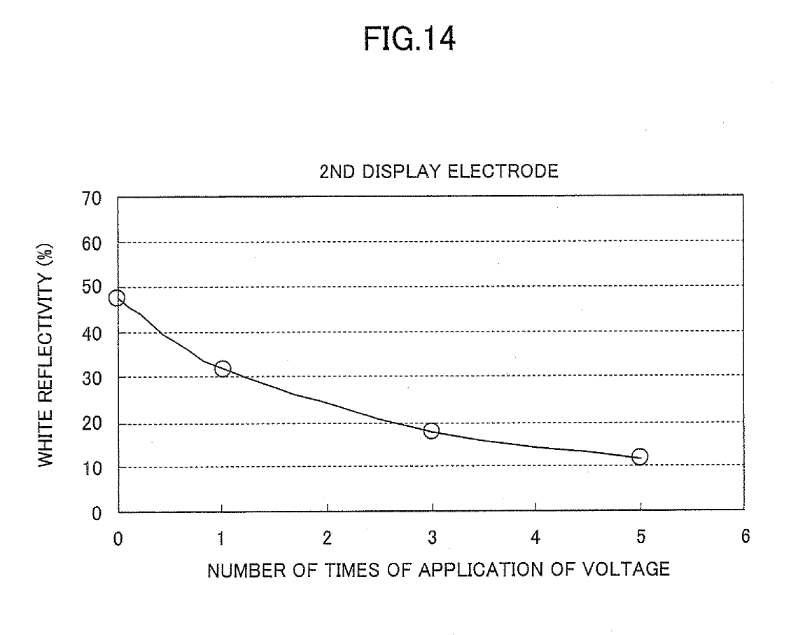

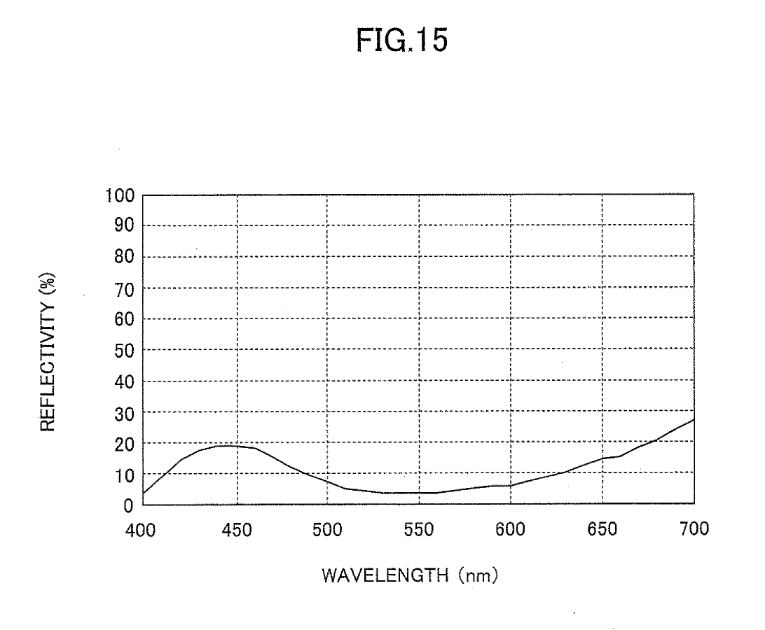

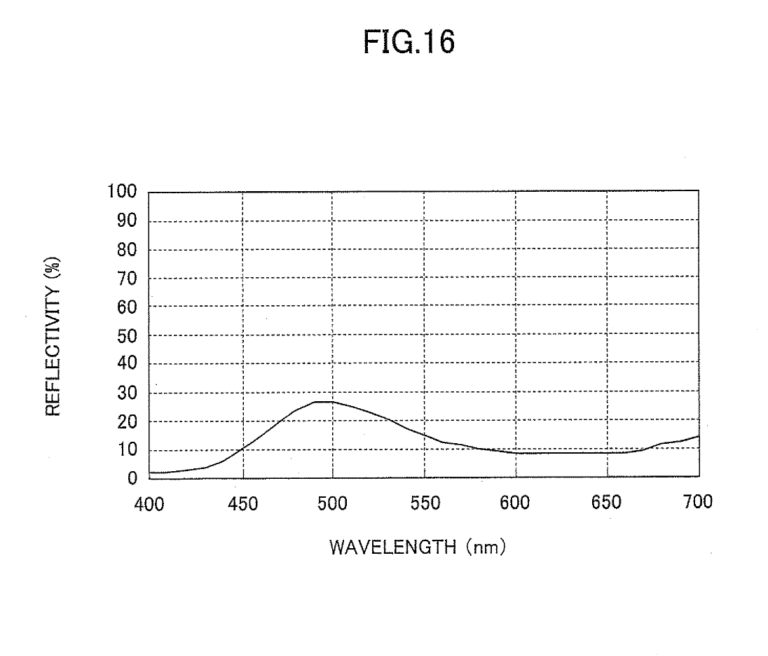

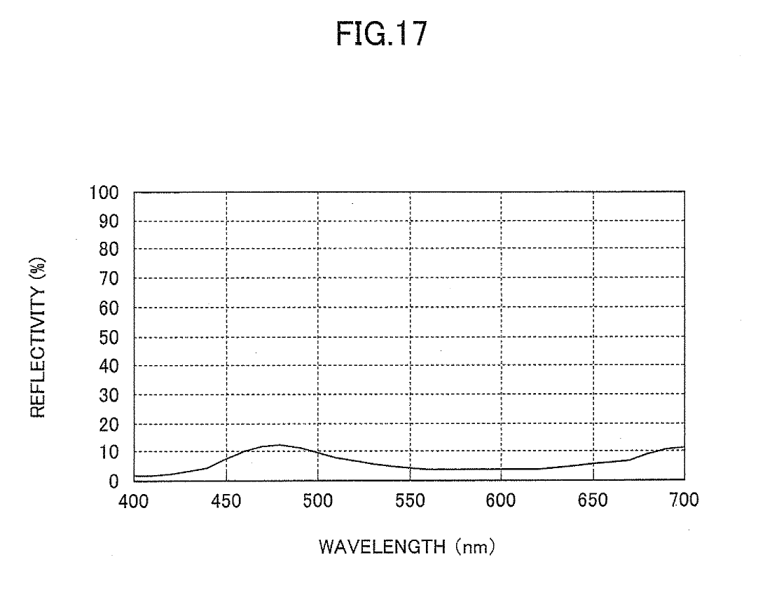

FIG. 13 is a graph indicating the relationship between the number of times of application of pulse voltage to the first display electrode and white reflectivity. FIG. 14 is a graph indicating the relationship between the number of times of application of pulse voltage to the second display electrode and white reflectivity. FIG. 15 is a graph indicating the reflectance spectrum during the appearance of blue. FIG. 16 is a graph indicating the reflectance spectrum during the appearance of green. FIG. 17 is a graph indicating the reflectance spectrum during the appearance of black.

As seen from FIGS. 13 and 14, the white reflectivity continuously decreased as the number of times of pulse application increased when the pulse voltage was applied to the first display electrode and when the pulse voltage was applied to the second display electrode. Namely, the color appears continuously darker as the number of times of pulse application increases, indicating the possibility that intermediate colors can be displayed.

In the case of application of the pulse voltage between the first display electrode and the opposite electrode, FIG. 15 shows an increase in reflectivity at wavelengths of around 440 nm, indicating the appearance of blue. In the case of pulse voltage application between the second display electrode and the opposite electrode, FIG. 16 shows an increase in reflectivity at wavelengths around 490 nm, indicating the appearance of green. In the case of pulse voltage application between the first and second display electrodes and the opposite electrode, FIG. 17 shows a general decrease in reflectivity compared to FIGS. 15 and 16, indicating the appearance of black.

Thus, by selecting the first display electrode or the second display electrode for voltage application, multicolor display can be performed easily. By controlling the number of times of voltage pulse application, intermediate colors can be displayed.

### Example 5

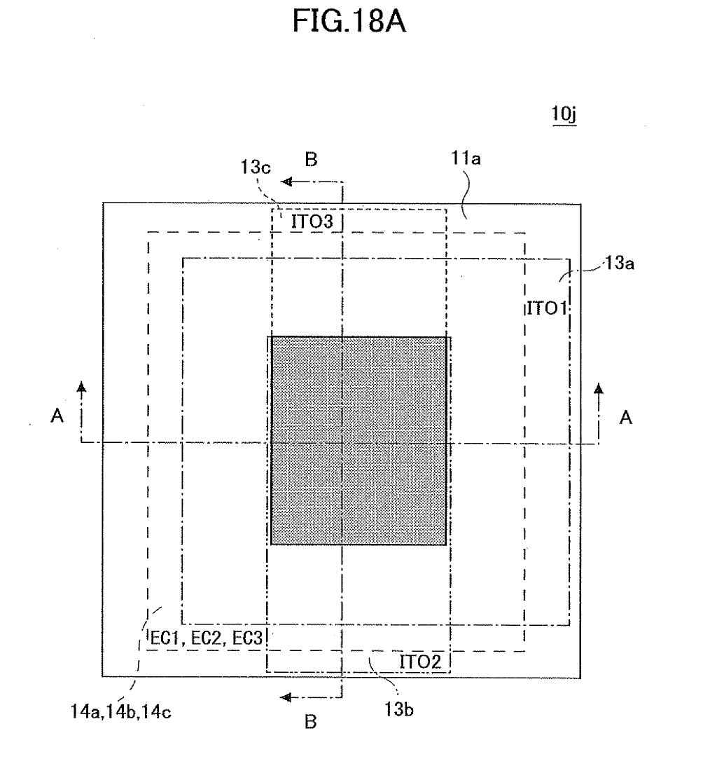

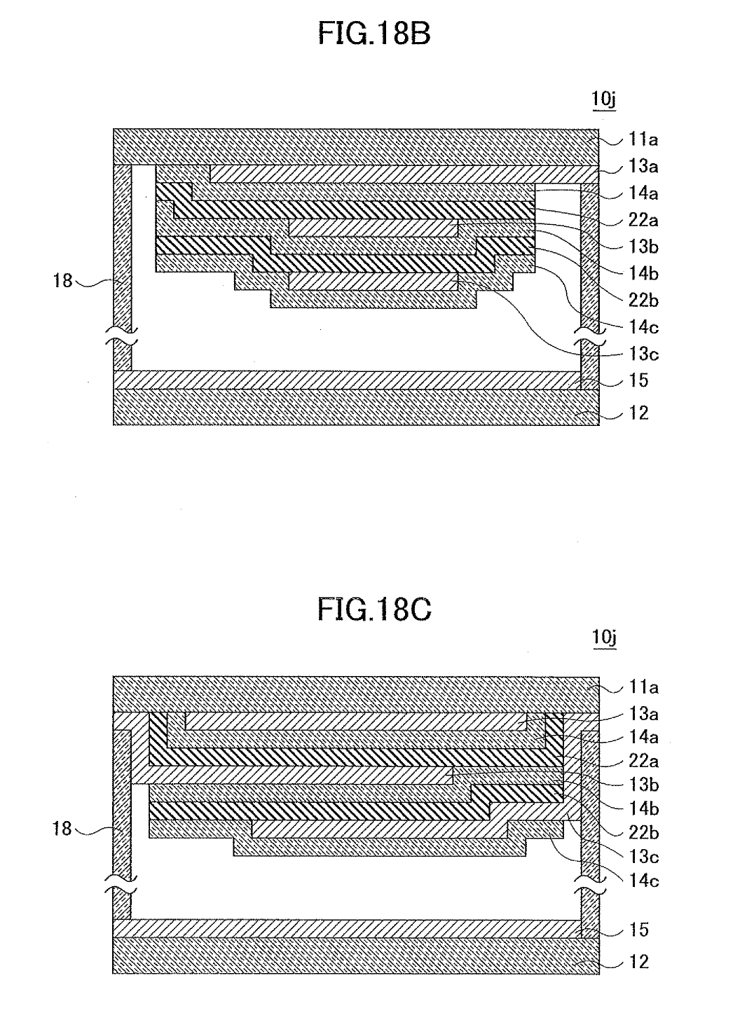

An electrochromic display apparatus 10j illustrated in FIGS. 18A through 18C was manufactured in the same way as in Example 1 with the exception that it included three display electrode layers and three electrochromic layers.

### Formation of Display Electrode and Electrochromic Layer

A glass substrate measuring 30 mm×30 mm was prepared, and an ITO film was formed in a 16 mm×23 mm area on an upper surface of the glass substrate by sputtering, to a thickness of about 100 nm, thereby forming the first display electrode. The sheet resistance across the ends of the first display electrode was about 200 Ω.

On the glass substrate with the first display electrode formed thereon, there was applied SP210 (manufactured by Showa Titanium Co., Ltd.) as a titanium oxide nanoparticle dispersion liquid by spin coating, followed by annealing at 120° C. for 15 min, forming a titanium oxide particle film. Thereafter, the glass substrate was further coated with a coating liquid by spin coating, the coating liquid comprising a 1 wt % 2,2,3,3-tetrafluoropropanol solution of a viologen compound expressed by General Formula (5). Annealing was then performed at 120° C. for 10 min, forming the first electrochromic layer including titanium oxide particles and the electrochromic compound.

The glass substrate with the first electrochromic layer formed thereon was further coated with a 0.1 wt % ethanol solution of poly-N-vinyl amide and a 0.5 wt % aqueous solution of polyvinyl alcohol by spin coating in order to form a protection layer. Thereafter, a film of ZnS—SiO₂ having a composition ratio of 8/2 was formed by sputtering to a film thickness of 140 nm, thus forming an inorganic insulating layer. Further, in a 10 mm×20 mm area on the surface of the glass substrate with the inorganic insulating layer of ZnS—SiO₂ formed thereon, an ITO film was formed by sputtering to a thickness of about 100 nm, thereby forming the second display electrode. The sheet resistance across the ends of the second display electrode was about 200 Ω.

The glass substrate with the second display electrode formed thereon was further coated with SP210 (manufactured by Showa Titanium Co., Ltd.) as a titanium oxide nanoparticle dispersion liquid by spin coating, followed by annealing at 120° C. for 15 min, forming a titanium oxide particle film. Then, the glass substrate was coated with a coating liquid by spin coating, the coating liquid comprising a mixture of a 1 wt % 2,2,3,3-tetrafluoropropanol solution of the viologen compound expressed by General Formula (5) and SP210 at a mixture ratio of 2.4/4. This was followed by annealing at 120° C. for 10 min, forming the second electrochromic layer including titanium oxide particles and the electrochromic compound.

The glass substrate with the first electrochromic layer formed thereon was coated with a 0.1 wt % ethanol solution of poly-N-vinyl amide and a 0.5 wt % aqueous solution of polyvinyl alcohol by spin coating, forming a protection layer. Thereafter, a film of ZnS—SiO₂ having a composition ratio of 8/2 was formed by sputtering to a film thickness of 140 nm, thus forming an inorganic insulating layer. Further, in a 10 mm×20 mm area on the surface of the glass substrate with the inorganic insulating layer of ZnS—SiO₂ formed thereon, an ITO film was formed by sputtering to a thickness of about 100 nm, thus forming the third display electrode. The sheet resistance across the ends of the third display electrode was about 200 Ω.

The glass substrate with the third display electrode formed thereon was further coated with SP210 (manufactured by Showa Titanium Co., Ltd.) as a titanium oxide nanoparticle dispersion liquid by spin coating, followed by annealing at 120° C. for 15 min, thereby forming the third electrochromic layer comprising titanium oxide particles. The glass substrate with the third electrochromic layer formed thereon was further coated with a 0.1 wt % ethanol solution of poly-N-vinyl amide and a 0.5 wt % aqueous solution of polyvinyl alcohol by spin coating, thus forming a protection layer. Thereafter, a film of ZnS—SiO₂ having a composition ratio of 8/2 was formed by sputtering to a film thickness of 35 nm, thus forming an inorganic insulating layer.

FIGS. 18A, 18B, and 18C illustrate the electrochromic display apparatus 10j according to Example 5. FIGS. 18A, 18B, and 18C are a plan view of the electrochromic display apparatus 10j, a cross section taken along line A-A, and a cross section taken along line B-B of FIG. 18A, respectively.

As illustrated in FIGS. 18B and 18C, the electrochromic display apparatus 10j includes the first display electrode 13a (ITO1), the first electrochromic layer 14a (EC1), the first insulating layer 22a, the second display electrode 13b (ITO2), the second electrochromic layer 14b (EC2), the second insulating layer 22b, the third display electrode 13c (ITO3), and the third electrochromic layer 14c (EC3). As illustrated in FIG. 18A, the electrochromic display apparatus 10j has a central area (with hatching) in which all of ITO1, EC1, ITO2, EC2, ITO3, EC3 are layered. The central area with hatching is referred to as a color appearance/disappearance evaluation area in which a color appearance/disappearance test is performed, as will be described later.

### Measurement of Inter-Electrode Resistance

The inter-electrode resistance between the first and second display electrodes of the electrochromic display apparatus 10j was about 10 MΩ, while the inter-electrode resistance between the second and third display electrodes was about 0.5 MΩ.

### Color Appearance/Disappearance Test

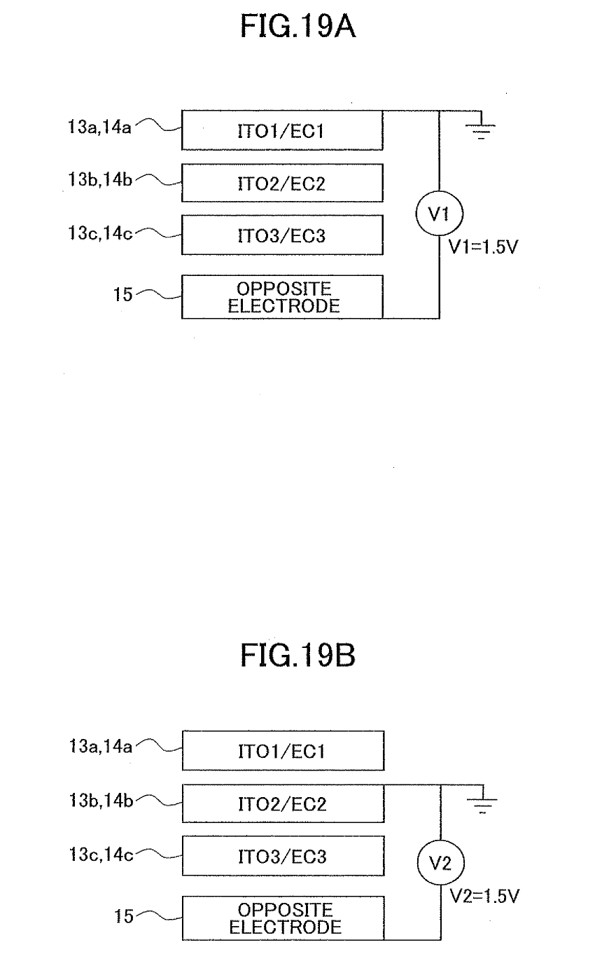

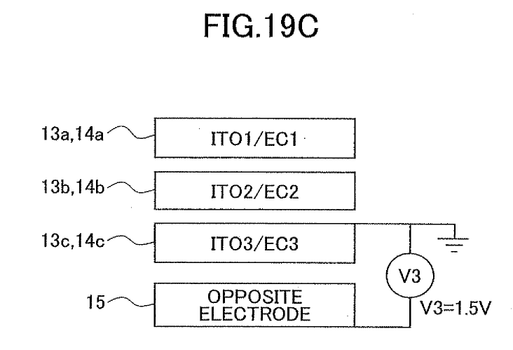

The electrochromic display apparatus 10j according to Example 5 was subjected to a color appearance evaluation involving voltage application for two sec such that potential differences were exhibited between the display electrodes and the opposite electrode as illustrated in FIGS. 19A through 19C.

Specifically, in the case of FIG. 19A, voltage was applied such that ITO1/EC1 had a 0 V potential while the opposite electrode had a potential of 1.5 V, with no voltage applied to ITO2/EC2 and ITO3/EC3. In the case of FIG. 19B, voltage was applied such that ITO2/EC2 had a 0 V potential while the opposite electrode had a 1.5 V potential, with no voltage applied to ITO1/EC1 and ITO3/EC3. In the case of FIG. 19C, voltage was applied such that ITO3/EC3 had a 0 V potential while the opposite electrode had a 1.5 V potential, with no voltage applied to ITO1/EC1 and ITO2/EC2.

As a result, in FIG. 19A, only the area of ITO1/EC1 exhibited a color. In the case of FIG. 19B, only the area of ITO2/EC2 exhibited a color. In the case of FIG. 19C, only the area of ITO3/EC3 exhibited a color. Thus, the first, the second, and the third display electrodes could be caused to independently exhibit colors.

### Example 6

An electrochromic display apparatus (not illustrated) was manufactured in the same way as Example 1 with the exception that the first electrochromic layer was formed by using a 2,2,3,3-tetrafluoropropanol solution containing 4 wt % of a terephthalic acid compound expressed by General Formula (6) and 20 wt % of the AMT100 titanium oxide particles (Tayca Corporation). Another difference from Example 1 was that the second electrochromic layer was formed by using a 2,2,3,3-tetrafluoropropanol solution containing 4 wt % of a terephthalic acid compound expressed by General Formula (7) and 20 wt % of AMT100.

The electrochromic display apparatus 10k further differed from Example 1 in that 35 wt % of titanium oxide particles (manufactured by Ishihara Sangyo Kaisha, Ltd.) having a primary particle diameter of 300 nm was dispersed in an electrolyte solution of dimethylsulfoxide in which 0.1 M of tetrabutylammonium perchlorate had been dissolved.

The inter-electrode resistance between the first and the second display electrodes of the electrochromic display apparatus 10k was about 10 MΩ, indicating good insulation.

### Color Appearance/Disappearance Test

The electrochromic display apparatus according to Example 6 was subjected to a color appearance/disappearance evaluation. The color appearance/disappearance evaluation involved irradiating the electrochromic display apparatus 10k with diffuse light using the LCD-5000 spectrophotometer (Otsuka Electronics Co., Ltd.). For voltage application, the FG-02 function generator (Toho Giken) was used to provide a pulse of 4.5 V for 100 ms, with the pulse interval of 10 ms when multiple pulses were applied.

The electrochromic display apparatus appeared white without voltage application, indicating a high white reflectivity of about 45%. When the first display electrode 13a was connected to the negative electrode and the opposite electrode 12 was connected to the positive electrode, magenta appeared upon application of pulse voltage. When the second display electrode 13b was connected to the negative electrode and the opposite electrode 12 was connected to the positive electrode, yellow appeared upon application of pulse voltage. When the first and the second display electrodes 13a and 13b were connected to the negative electrode and the opposite electrode 12 was connected to the positive electrode, red appeared upon application of pulse voltage.

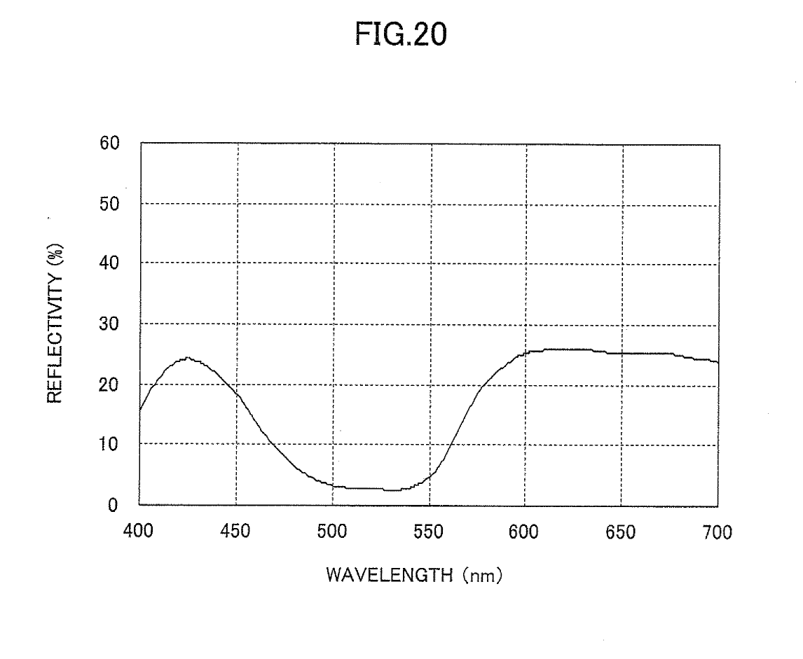

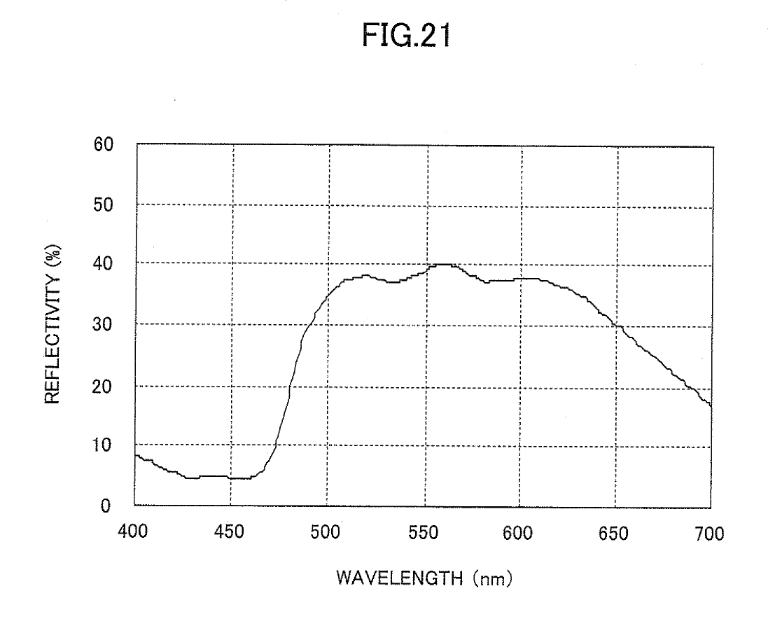

FIG. 20 is a graph indicating the reflectance spectrum upon the appearance of magenta. FIG. 21 is a graph indicating the reflectance spectrum upon the appearance of yellow. In the case of FIG. 20 where pulse voltage was applied between the first display electrode 13a and the opposite electrode 12, the reflectivity increased at wavelengths of around 420 nm and 600 nm or more, indicating the appearance of magenta. In the case of FIG. 21 when pulse voltage was applied between the second display electrode 13b and the opposite electrode 12, the reflectivity increased at wavelengths of around 500 to 600 nm, indicating the appearance of yellow.

Thus, by selecting the first display electrode 13a or the second display electrode 13b for voltage application, multicolor display can be easily realized. By controlling the number of times of voltage pulse application, intermediate colors can be displayed.

### Example 7

An electrochromic display apparatus (not illustrated) was manufactured in the same way as in Example 4 with the exception that the conditions for manufacturing the opposite electrode and assembling the electrochromic display apparatus were different.

### Formation of Opposite Electrode

Separately from the substrate on which the display electrodes were formed, a glass substrate measuring 30 mm×30 mm was prepared, and a transparent conductive thin-film of tin oxide was formed on an entire upper surface of the glass substrate. An upper surface of the glass substrate with the transparent conductive thin-film formed thereon was further coated with a 20 wt % 2,2,3,3-tetrafluoropropanol dispersion liquid by spin coating to a thickness of about 2 μm, the dispersion liquid containing dissolved tin oxide particles (Mitsubishi Materials Corporation) having a primary particle diameter of 30 nm. Thereafter, annealing was performed at 120° C. for 15 min, thereby forming the opposite electrode.

### Manufacture of Electrochromic Display Apparatus

An electrolyte white ink was prepared by mixing the PTC10 UV curable ink (Jujo Chemical Co., Ltd.), perchlorate chloride, propylene carbonate, and titanium oxide particles (Ishihara Sangyo Kaisha, Ltd.) having a primary particle diameter of 300 nm, at a weight ratio of 10/1/2/2.

The electrolyte white ink was then applied to the opposite electrode manufactured as described above in a pattern such that dots with a diameter of 1 mm and a thickness of about 5 μm are arranged with center-to-center intervals of 2.5 mm.

Then, the display substrate was laid on the opposite substrate such that the display electrodes and the electrochromic layers of the display substrate were opposite the coating of the electrolyte white ink on the opposite substrate. After left standing for 10 min, UV irradiation was performed to cure the electrolyte white ink, thus fixing the display substrate onto the opposite substrate.

### Measurement of Display Inter-Electrode Resistance

The inter-electrode resistance between the first and second display electrodes of the electrochromic display apparatus was measured. The resistance was about 10 MΩ, indicating good insulation.

### Color Appearance/Disappearance Test

A color appearance evaluation was conducted by applying a voltage to the electrochromic display apparatus according to Example 7. The voltage applied was 2.5 V, and the duration of application was two s. The display electrodes were connected to the negative electrode, while the opposite electrode was connected to the positive electrode.

As a result, the first display electrode and the second display electrode could independently exhibit blue and green, respectively. It was also possible to cause only the patterned electrolyte white ink portion to exhibit a color.

### Example 8

An electrochromic display apparatus was manufactured in the same way as in Example 1 with the exception that the viologen compound expressed by General Formula (4) was replaced by a viologen compound expressed by General Formula (8) in which a furan structure, which is a heterocyclic compound, is introduced between pyridine ring alkyl cation structures.

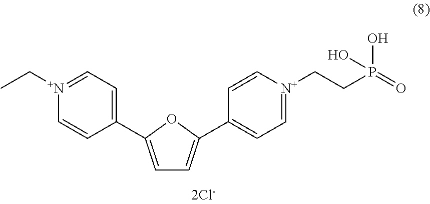

Another exception is that the viologen compound expressed by General Formula (5) was replaced by a viologen compound expressed by General Formula (9) in which a thiophene structure, which is a heterocyclic compound, was introduced between the pyridine ring alkyl cation structures.

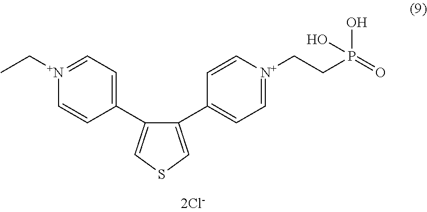

When the voltages were applied to the display electrodes of the electrochromic display apparatus, the first and second display electrodes could independently exhibit magenta and yellow, respectively. Further, the color that had been independently exhibited once could be retained stably.

### Comparative Example 1

An electrochromic display apparatus according to Comparative Example 1 was manufactured in the same way as in Example 4 with the exception that no insulating layer was formed.

The inter-electrode resistance between the first and second display electrodes of the electrochromic display apparatus was measured. The measurement indicated a resistance of about 200Ω, indicating poor insulation.

The electrochromic display apparatus according to Comparative Example 1 was also subjected to color appearance/disappearance in the same way as in Example 4. When the second display electrode was connected to the negative electrode and the opposite electrode was connected to the positive electrode, the electrochromic display apparatus appeared black upon application of pulse voltage, indicating a failure to exhibit blue due to the first electrochromic layer and green due to the second electrochromic layer independently.

Although this invention has been described in detail with reference to certain embodiments, variations and modifications exist within the scope and spirit of the invention as described and defined in the following claims.

The present application is based on the Japanese Priority Application No. 2009-112006 filed May1, 2009, the entire contents of which are hereby incorporated by reference.

1. An electrochromic display apparatus comprising:
a display substrate;
an opposite substrate disposed opposite the display substrate;
an opposite electrode disposed on the opposite substrate;
a plurality of display electrodes disposed between the display substrate and the opposite electrode, the display electrodes being separated from each other;
a plurality of electrochromic layers disposed on the corresponding display electrodes; and
an electrolyte disposed between the display electrodes and the opposite electrode,
wherein an electric resistance between one display electrode and another display electrode is greater than an electric resistance of the one or the other display electrode, and
wherein one or more display electrodes disposed between the display electrode closest to the display substrate and the opposite electrode are configured to be permeable to the electrolyte.

2. The electrochromic display apparatus according to claim 1, wherein the electrochromic layers include an electrochromic compound and metal oxide particles.

3. The electrochromic display apparatus according to claim further comprising a reflecting layer disposed between the electrochromic layer closest to the opposite substrate and the opposite electrode, or on the side of the opposite substrate opposite to the opposite electrode.

4. The electrochromic display apparatus according to claim 1, wherein the electrolyte is patterned in the form of a matrix.

5. The electrochromic display apparatus according to claim 1, further comprising an insulating layer between the display electrodes in order to insulate the display electrodes from one another.

6. The electrochromic display apparatus according to claim 1, wherein one of the electrochromic layers that has the highest threshold voltage for exhibiting a color is disposed corresponding to the display electrode closest to the display substrate.

7. The electrochromic display apparatus according to claim 1, wherein one of the electrochromic layers that has the highest threshold voltage for not exhibiting a color is disposed corresponding to the display electrode closest to the display substrate.

8. The electrochromic display apparatus according to claim 1, wherein the electrochromic layers disposed on the corresponding display electrodes are configured to exhibit different colors.

9. The electrochromic display apparatus according to claim 1, wherein at least one of the electrochromic layers includes a viologen compound expressed by a general formula (1): 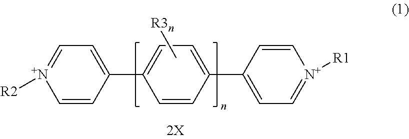
wherein R1, R2, and R3 are alkyl groups or aryl groups with a carbon number of 1, 2, 3, or 4 which may independently include a substitution group, where at least one of R1 and R2 is selected from COOH, PO(OH)₂, and Si(OCₖH₂ₖ₊₁)₃; X is a monovalent anion; n is 0, 1, or 2; m is 0, 1, 2, 3, or 4; and k is 0, 1, or 2.

10. The electrochromic display apparatus according to claim 1, wherein at least one of the electrochromic layers includes a terephthalic acid compound expressed by a general formula (2): 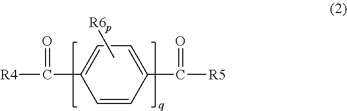
wherein R4, R5, and R6 are alkyl groups, alkoxy groups, or aryl groups with a carbon number of 1, 2, 3, or 4, where at least one of R4 and R5 is selected from COOH, PO(OH)₂, and Si(OCₖH₂ₖ₊₁)₃; q is 1 or 2; p is 0, 1, 2, 3, or 4; and k is 0, 1, or 2.

11. The electrochromic display apparatus according to claim 1, wherein at least one of the electrochromic layers includes a compound expressed by a general formula (3) in which a heterocyclic compound derivative structure is located between two pyridine ring alkyl cation structures: 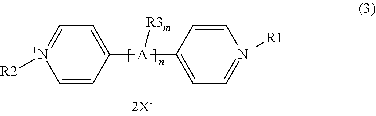
wherein R1, R2, and R3 are alkyl groups or aryl groups with a carbon number of 1, 2, 3, or 4 which may independently include a substitution group, where at least one of R1 and R2 is selected from COOH, PO(OH)₂, and Si(OCₖH₂ₖ₊₁)₃; X is a monovalent anion; n is 0, 1, or 2; m is 0, 1, or 2; k is 0, 1, or 2; and A is a heterocyclic compound derivative.

12. The electrochromic display apparatus according to claim 9, wherein all of the electrochromic layers include a viologen compound expressed by the general formula (1): 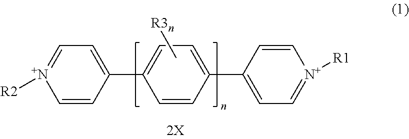
wherein R1, R2, and R3 are alkyl groups or aryl groups with a carbon number of 1, 2, 3, or 4 which may independently include a substitution group, where at least one of R1 and R2 is selected from COOH, PO(OH)₂, and Si(OCₖH₂ₖ+₁)₃; X is a monovalent anion; n is 0, 1, or 2; m is 0, 1, 2, 3, or 4; and k is 0, 1, or 2.

13. The electrochromic display apparatus according to claim 10, wherein all of the electrochromic layers include a terephthalic acid compound expressed by the general formula (2): 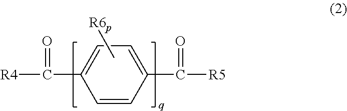
wherein R4, R5, and R6 are alkyl groups, alkoxy groups, or aryl groups with a carbon number of 1, 2, 3, or 4, where at least one of R4 and R5 is selected from COOH, PO(OH)₂, and Si(OCₖH₂ₖ₊₁)₃; q is 1 or 2; p is 0, 1, 2, 3, or 4; and k is 0, 1, or 2.

14. The electrochromic display apparatus according to claim 11, wherein all of the electrochromic layers include a compound expressed by the general formula (3) in which a heterocyclic compound derivative structure is located between two pyridine ring alkyl cation structures: 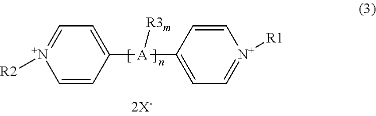
wherein R1, R2, and R3 are alkyl groups or aryl groups with a carbon number of 1, 2, 3, or 4 which may independently include a substitution group, where at least one of R1 and R2 is selected from COOH, PO(OH)₂, and Si(OCₖH₂ₖ₊₁)₃; X is a monovalent anion; n is 0, 1, or 2; m is 0, 1, or 2; k is 0, 1, or 2; and A is a heterocyclic compound derivative.
